(19) United States
(12) Patent Application Publication
(10) Pub. No.: US 2004/0230505 A1
(43) Pub. Date: Nov. 18, 2004

(54) Method and system for managing a non-qualified deferred compensation program using hedging

(76) Inventors: Chris Garlich, St. Louis, MO (US); Seth Koppes, Scottsdale, AZ (US); Bill Meier, St. Louis, MO (US); Mark Gilje, St. Louis, MO (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/437,385

(22) Filed: May 14, 2003

(51) Int. Cl. G06F 17/60

(52) U.S. Cl. 705/35

(57) ABSTRACT

A compensation tracking system provides not only plan tracking at the plan participant level, but also plan participant payment benefit tracking (also referred to as “payout bucket” tracking). Such systems may require that plan participant account balances be capable of being allocated into several targeted investments or indexes. In the context of benefits that are hedged using qualifying hedging transactions, the qualifying hedging transactions are broken down into an aggregate of mini-hedges attributable to each plan participant's possible benefit payments.

### BACKGROUND OF THE INVENTION

1. Field of the Invention

The present invention is directed to a method and system for managing the assets and liabilities of Non-Qualified Deferred Compensation (NQDC) plans, and more particularly to a method and system for tracking, reconciling and administering the values associated with hedging liabilities under NQDC plans using assets including derivatives and notional principal contracts.

2. Discussion of the Background

Known systems, including the system described in assignee's U.S. Pat. No. 5,999,917 (hereinafter “the '917 patent”), to Facciani, et al., and issued Dec. 7, 1999, are capable of managing the assets and liabilities of NQDC plans. (The '917 patent is incorporated herein by reference.) For example, an employer acting as a plan sponsor may offer a NQDC plan where participants can choose to defer salary or bonuses until some time in the future.

The plan participant can choose an allocation among various hypothetical funds, or “referenced funds,” as specified in the NQDC plan documents. The account balance(s) of the plan participant would then accumulate as if the deferrals were invested in those referenced funds. The term “fund” in “referenced fund” is used to more easily differentiate “referenced funds” from “targeted investments” discussed below. Accordingly, “referenced fund,” as used to describe the present invention, is intended to encompass funds, indexes, interest-based investments and any other alternative that a plan sponsor may offer in its NQDC plan.

Although the plan sponsor promises to pay the plan participant the accumulated account balance, there is no requirement that the plan sponsor purchase the same referenced funds or any fund at all. However, as a prudent management strategy to manage the cost of certain NQDC plans, many plan sponsors do purchase assets that offer similar investment performance to the referenced funds. These assets are sometimes referred to as “targeted investments” or “targeted funds.” As used herein, “targeted investments” refers to the investments selected by the plan sponsor to manage its exposure to the liability created as a result of a participant making a deferral and selecting a “referenced fund”; however, the use of the term “targeted investment” does not necessarily mean that the plan sponsor directly purchases or owns shares of the “targeted investment.” This process of selecting targeted investments to manage a plan sponsor's exposure to the liability created as a result of a participant making a deferral and selecting a “referenced fund” is referred to herein as “mapping.”

Based on a plan participant selecting a referenced fund, the plan sponsor may “map” no targeted investment, one targeted investment, or plural targeted investments to the selected referenced fund. Conversely, two referenced funds may be combined into a single targeted investment. The mapping of “referenced funds” to “targeted investments” is dynamic and may be changed during the lifetime of the plan, as described in additional detail below.

One problem facing plan sponsors that attempt to hedge the liabilities of their NQDC plans is that the referenced funds grow without triggering current taxes, however, any earnings on the targeted investment are subject to current taxes. This creates a timing mismatch on taxation between the growth of the liability, as represented by the referenced fund, and the growth of the asset used to hedge that liability.

Certain tax rules with respect to hedging transactions have been created so that gains or losses on these hedging transactions must be matched with the corresponding gains or losses for the item being hedged. Among other things, these rules require a company that enters into a hedging transaction to manage its risk to match the timing of the income, deduction, gain or loss from the hedging transaction with the timing of the income, deduction, gain or loss from the item being hedged.

As a result of this favorable treatment companies have entered into various derivatives contracts and/or Notional Principal Contracts including qualifying hedging transactions (e.g., swaps, forward contracts, options, puts, calls, etc. which may include prepaid provisions and generally encompasses the use of derivatives) that manage the risks, including the price risk, associated with a company's NQDC plan.

A benefit of utilizing qualifying hedging transactions in connection with NQDC benefit liabilities is that gains or losses associated with the hedging transactions would be deferred until the time that the liability discharge of the NQDC benefit occurs. For example, the timing of the deductions associated with NQDC benefits is only realized at the time each individual plan participant ultimately receives a plan benefit payment and must report income on his/her tax return. Therefore, administrative systems must be able to track the values, including gain or loss associated with the qualifying hedging transaction, until the discharge of the liability under the NQDC plan. In addition, these values must be tracked to the level that corresponds with each benefit payment that may be received by an individual plan participant. As a result, the present invention tracks the results of the qualifying hedging transaction to this level to achieve the deferred tax treatment described herein. As used herein, a “liability discharge” refers to at least one of a benefit payment and a forfeiture. Forfeitures can include penalties and reductions in hypothetical account balances for changes in the payout bucket or plan's payout conditions (e.g., a 10% forfeiture resulting from a request to change a payout date from 65 to 60 years old). Forfeitures may also result from the plan participant's termination of employment before vesting occurs.

The liabilities specific to an individual plan participant's election of a certain payout scheme is referred to as a “payout bucket.” The liabilities associated with a payout bucket may be allocated among one or more referenced funds and may be the result of one or more deferrals made by the individual plan participant. For example, an individual plan participant with a young child could elect to make a deferral (into a first “payout bucket”) that would pay a lump sum benefit payment in 10 years when the child would reach college age (e.g., for purposes of funding children's college expenses). Additionally, that same plan participant could elect to make another deferral (into a second “payout bucket”) to be paid out at age 65 (e.g., for purposes of funding retirement needs). In order to follow the hedging transaction tax rules a plan sponsor would need to track the values associated with the qualifying hedging transaction separately for each payout bucket (referred to herein as a “mini-hedge”). To create a more efficient transaction, the mini-hedges may be aggregated for purposes of entering into a hedging agreement with a counter-party but, for administrative purposes, records would need to be maintained at the mini-hedge level.

Patent Publication 2002/0174044 to Marshall (hereinafter “the '044 publication”) describes a method for hedging liabilities associated with a deferred compensation plan. (The contents of the '044 publication are incorporated herein by reference.) However, '044 publication does not address several of the features of the present invention as described hereinafter.

### SUMMARY OF THE INVENTION

It is an object of the present invention to provide a method and system for tracking, reconciling and administering the values associated with hedging liabilities under NQDC plans using assets including qualifying hedging transactions and optionally non-qualifying hedging transactions.

According to one aspect of the present invention, the administration system provides tracking of liabilities (i.e., amounts due to plan participants under the terms of their non-qualified plan based on the accumulated notional value of their deferrals) and assets (i.e., the underlying investments or transactions made or entered into by the plan sponsor in order to offset the liabilities due to the plan participant), where at least some of the assets are qualifying hedging transactions using a counter-party and therefore are eligible for special tax treatment if certain qualifying rules are followed.

In one embodiment of the present invention, plan sponsors track hedging transactions on a “payout bucket” basis even when the hedging transactions are implemented on an aggregate basis. By assessing and tracking gains, losses, fees, interest and other values and costs of managing qualifying hedging transactions, the plan sponsor can defer the tax treatment of qualifying hedging transactions until a plan participant actually receives an NQDC benefit payment.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a block diagram of various interacting entities in an NQDC plan that utilizes hedging transactions to manage its exposure to NQDC liabilities for some groups;

FIG. 1B is a block diagram illustrating a multi-level plan hierarchy;

FIG. 2 is a schematic illustration of an exemplary computer according to the present invention for administering an NQDC plan that utilizes qualifying and non-qualifying hedging transactions;

FIG. 3 is a flowchart of how plan liabilities are tracked by the administration system of FIG. 2;

FIG. 4 is a flowchart of the general overview of a plan set-up process for tracking qualifying hedging transactions of a plan sponsor's plan using the administration system of FIG. 2;

FIG. 5a is a flow diagram illustrating a mapping of referenced funds to targeted investments that are eligible for hedging for a first group of participants;

FIG. 5b is a flow diagram illustrating a mapping of referenced funds to targeted investments that are eligible for hedging for a second group of participants in which aggregate targeted investments below a plan sponsor-specified threshold are not hedged, even if they would otherwise be targeted investments that are eligible for hedging;

FIG. 5c is a flow diagram illustrating a mapping of referenced funds to targeted investments that are eligible for hedging for a third group of participants in which a single referenced fund may be mapped to plural targeted investments;

FIG. 5d is a flow diagram illustrating a mapping of referenced funds to targeted investments that are eligible for hedging for a fourth group of participants for which the plan sponsor ultimately does not hedge the targeted investments (as shown in FIG. 6) for the group because their aggregate is below a sponsor-specified threshold;

FIG. 6 is a flow diagram of the aggregation process of the targeted investments of FIGS. 5a-5d, wherein the targeted investments of groups 1-3 are subject to a hedging transaction but the targeted investments of groups 4 and 5 are not;

FIG. 7 is a flowchart of a hedging transaction asset monitoring process according to the present invention;

FIGS. 8a and 8b are flow diagrams of exemplary hedging transaction assets (separated into payout buckets) being tracked by the process according to FIG. 7;

FIG. 8c is a flow diagram of exemplary hedging transaction assets, tracked by the present invention, in which dividends and/or distributions are paid out to the plan sponsor immediately rather than being carried forward as in FIGS. 8a and 8b;

FIG. 9a is an illustration of the process of assessing fees corresponding to a hedging transaction to their appropriate group for tax deferral reasons;

FIG. 9b is an illustration of the process of assessing fees corresponding to a hedging transaction to the mini-hedge corresponding to each payout bucket for tax deferral reasons;

FIG. 10 is a flowchart of a rebalancing process on the hedging transaction asset-side that is used when a plan participant modifies referenced fund allocations, or other additions or reductions in liabilities occur, on a liability-side;

FIG. 11 is an illustration of a change in allocation of targeted investments as a result of the rebalancing process; and

FIG. 12 is a flowchart showing a settlement process for hedging transactions according to the present invention.

### DETAILED DESCRIPTION OF THE PREFERRED EMBODIMENTS

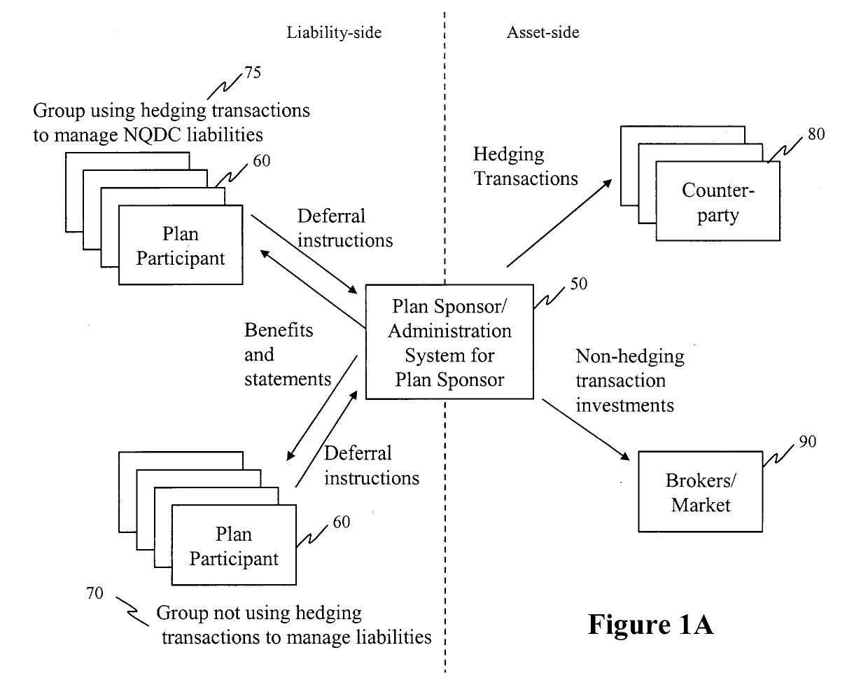

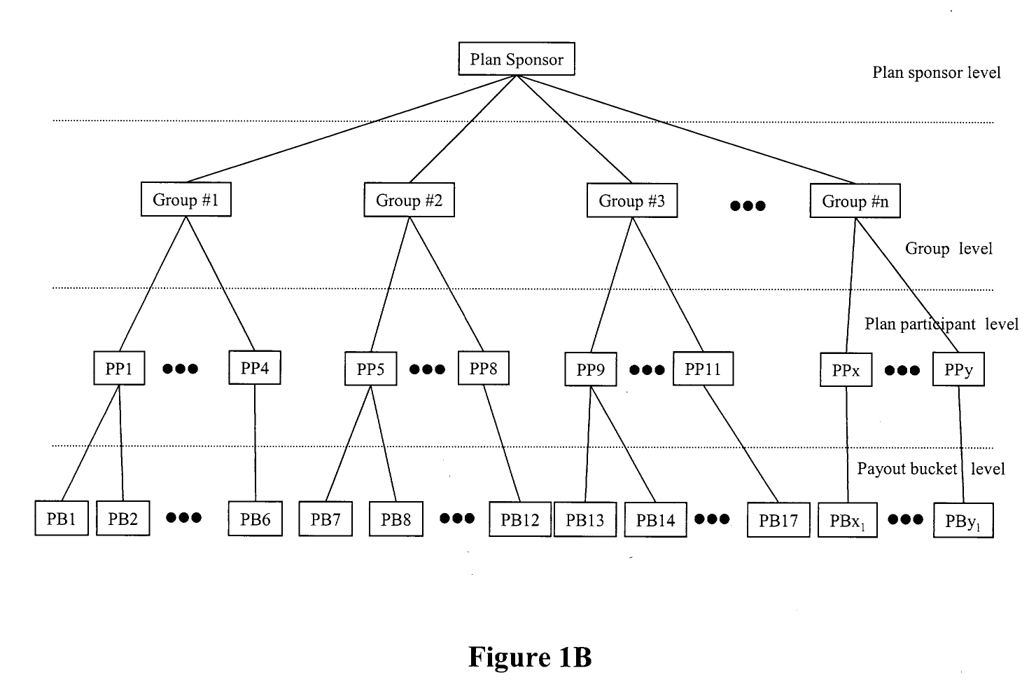

Referring now to FIG. 1A, the block diagram illustrates various interacting entities in an NQDC plan that utilizes hedging transactions. On the liability-side of the diagram, plan participants 60 send deferral instructions to a plan sponsor or the administration system for the plan sponsor 50. The administration system 50 controls the payment of benefits and the production of statements on behalf of the plan sponsor. The administration system 50 also controls tracking, reconciling and administering the values associated with hedging liabilities under NQDC plans using assets including derivatives and/or notional principal contracts.

As will be described in greater detail, the plan participants 60 are assigned to groups (e.g., a group using hedging transactions to manage the plan sponsor's NQDC liabilities 75 and a group that will not use hedging transactions to manage the plan sponsor's NQDC liabilities 70). This assignment to a group is based on requirements of the plan sponsor 50 (e.g., in order to group plan participants that belong to separate divisions having separate profit/loss statements, or groups that are separate for tax, insurance or regulatory (e.g., OCC, SEC or Treasury) purposes).

As described herein, and as illustrated in FIG. 1B, the present invention creates a multi-level plan hierarchy. A first level of the hierarchy is the payout bucket level. The second level of the hierarchy is the plan participant level. Each plan participant is associated with at least one payout bucket on the payout bucket level. The third level of the hierarchy is the group level. Each group is associated with at least one plan participant on the plan participant level. The fourth level of the hierarchy is the plan level. Each plan is associated with at least one group at the group level. However, as would be understood by one of ordinary skill in the art, a plan hierarchy is not limited to any particular number of levels and more or fewer levels may be used without departing from the teachings of the present invention. For example, the payout bucket level and the plan participant level may be merged into a single level in plans where plan participants are allowed to only have a single payout bucket. Similarly, an additional level may be added when groups and divisions need to be tracked separately.

In the exemplary embodiment of FIG. 1B, the group level includes “n” groups, where the “. . . ” symbol is intended to represent other groups that are not shown between group #3 and group ##n. Similarly, group #1 is illustrated as having four plan participants at the plan participant level. Again, the “. . . ” symbol is intended to represent other plan participants that are not shown. In group #n, the starting plan participant is labeled as “PPx” and the last plan participant is labeled as “PPy”, where there may be any number of plan participants (including none) between “PPx” and “PPy”. At the payout bucket level, any number of payout buckets may be associated with a plan participant. At the payout bucket level, the “. . . ” symbol is intended to represent a number of non-illustrated payout buckets corresponding to non-illustrated plan participants. PBx₁ is intended to represent the first payout bucket (of potentially several payout buckets) of plan participant PPx. Similarly, PBy₁ is intended to represent the first payout bucket (of potentially several payout buckets) of plan participant PPy.

On the asset-side of the block diagram of FIG. 1A, the plan sponsor tracks qualifying hedging transactions with at least one counter-party 80 and non-hedging transaction investments (traded in a particular market or with a particular broker 90). The qualifying hedging transactions are tracked (and certain qualifying rules are followed) so that the assets can be properly treated for tax purposes.

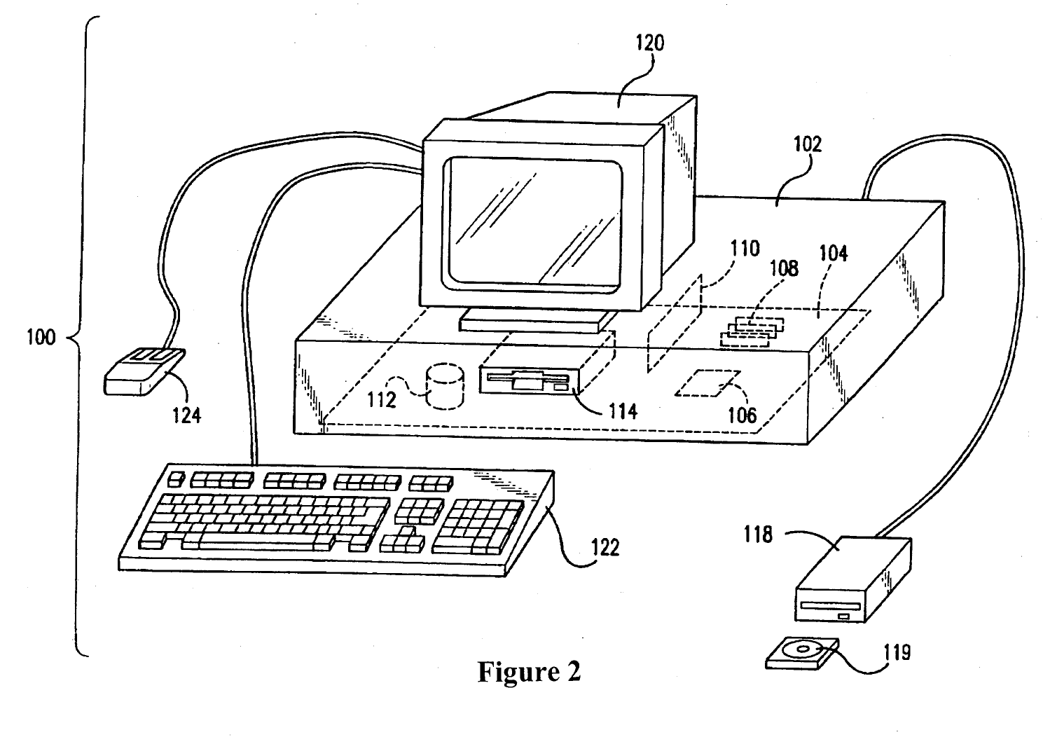

Turning to FIG. 2, there is shown a schematic illustration of an exemplary computer system 100 for managing a deferred compensation program or plan. The computer system 100 has a housing 102 which houses a motherboard 304 which contains a CPU 106 (e.g., Intel Pentium, Intel Pentium II, P3, P4, Intel Celeron, Intel Pentium M, Intel Itanium, HP Alpha, IBM/Motorola Power PC, AMD Athlon, AMD Duron, and Sun UltraSPARC), memory 108 (e.g., DRAM, ROM, EPROM, EEPROM, SRAM, SDRAM, RDRAM, and Flash RAM), and other optional special purpose logic devices (e.g., ASICs) or configurable logic devices (e.g., GAL and reprogrammable FPGA).

The computer 208 could further include plural input devices (e.g., a keyboard 122, mouse 124 and a modem, network interface card, or other communications adapter), and a display card 110 for controlling monitor 120. In addition the computer system 100 includes storage devices which can include a floppy disk drive 114; other removable media devices (e.g., compact disc or digital versatile disc 119, tape, and removable magneto-optical media); and a hard disk 112, or other fixed, high density media drives, connected using an appropriate devices bus (e.g., a SCSI bus, an Enhanced IDE bus, or a Serial ATA bus). Although compact disc 119 is shown in a disc caddy, the compact disc 119 can be inserted directly into CD-ROM drives which do not require caddies. Also connected to the same device bus or another device bus as the high density media drives the computer 100 may additionally include an optical disc (e.g., compact disc or DVD) reader 118, an optical disc reader/writer unit or an optical disc jukebox. In addition, a printer (not shown) also provides printed copies of participant positions.

The computer system 100 further includes at least one computer readable medium. Examples of such computer readable media are compact discs 119, hard disks 112, floppy disks, USB storage devices, tape, magneto-optical disks, PROMs (e.g., EPROM, EEPROM, Flash EPROM), DRAM, SRAM, SDRAM, and RDRAM. Stored on any one or on a combination of the computer readable media, the present invention includes software for controlling both the hardware of the computer 100 and for enabling the computer 100 to interact with a human user or other devices. Such software may include, but is not limited to, device drivers, operating systems and user applications, such as development tools and (graphical) system monitors. Together, the computer readable media and the computer code thereon form a computer program product of the present invention. Computer code for implementing the method of the present invention can be implemented in any conventional computer programming language or in a combination of computer programming languages, including assembly, procedural languages, and object oriented languages, and may be in any one or a combination of forms (e.g., executable programs, scripts, dynamic and statically linked libraries, and interpreted code). Examples of such languages include C, C++ and Java. Similarly, application development toolkits including objects, “widgets” and controls (e.g., Active X controls) can also be used. Any one or a combination of these types of code can be combined into a computer software component which can be run on a hardware component (e.g., any general purpose computer, digital signal processor (DSP)-based computer or custom-designed hardware including “system on a chip” design). Thus, the term “component” as used herein corresponds to any combination of hardware components and software components.

Using the computer system described above, various aspects of the plan administration functions are carried out as described more fully below. To achieve this administration, plan participation information and performance information (e.g., returns on or values of various financial instruments) are gathered from at least one information source. The information can be “uploaded” into the administration system using any of the known techniques in the art (e.g., direct manual input using a user input device (e.g., a keyboard or mouse), input using electronic scanning or bar code reading, direct file transfer from a removable medium or indirect file transfer using a communications adapter over a communications link). The system can likewise combine information from all types of file transfers. The transfers also can occur from plural information sources (e.g., an information source providing stock information and an information source providing bond or futures information). Such transfers can be made over local area networks or wide area networks (e.g., the Internet). Such transfers may be made either using a wired network (e.g., Ethernet, Fast Ethernet, Gigabit Ethernet, T1, T3, DS1, DS3, DSL, ADSL, ISDN, and Broadband Cable) or wirelessly (e.g., 802.11b, 802.11a, 802.11g). Such transfers may be made using network protocols (e.g., TCP/IP, IPv6, NetBIOS, Netbeui, IPX/SPX, PPP, PPoE, MP, SMTP, POP3, IMAP, AppleTalk, FTP, HTTP, SSL).

The computer system can be any of, or a combination of, local computers and remote computers. Remote computers can be controlled via a Web-style interface or using ASPs.

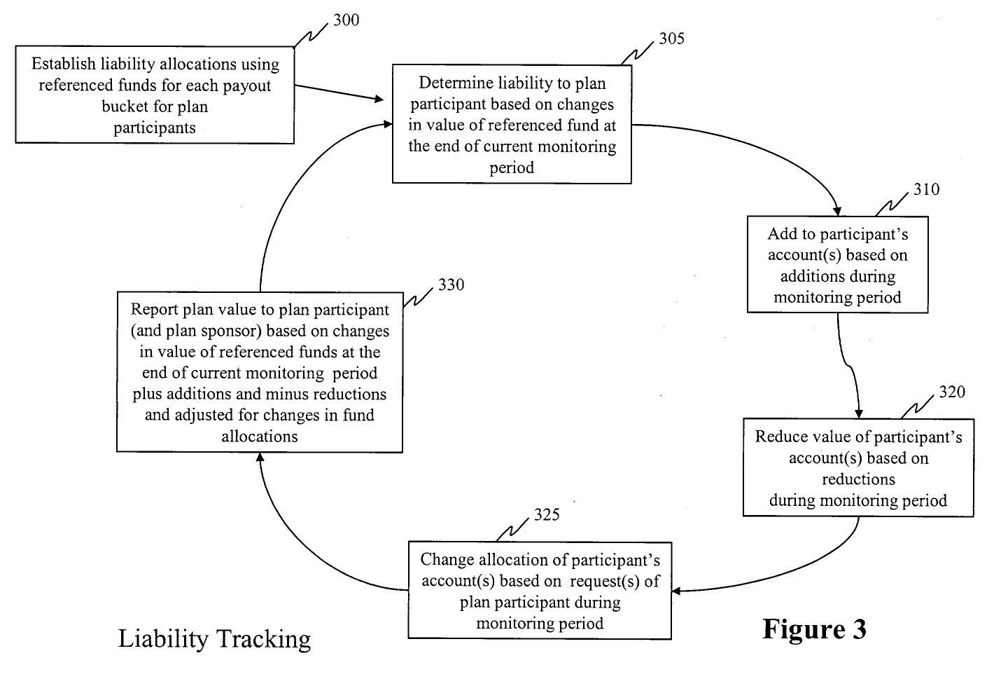

On the liability-side, the administration system 50 performs liability tracking, for example, as shown in FIG. 3. Initially, in step 300, the administration system 50 establishes “initial” liability allocations, i.e., deferred amounts, by allowing a plan participant to either (1) select a number of referenced funds or (2) by including a plan participant with existing deferrals into a group of participants that will use qualifying hedging transactions. Thus, an “initial” deferral, as used herein, corresponds to a time when the system of the present invention begins tracking a plan participant for qualifying hedging transaction purposes. As described above, this represents a plan sponsor's obligation to pay a certain amount, and may not (and often does not) correspond to any actual investment that can be purchased. Examples of referenced funds include: prime rate +2%, S&P 500 −0.5%, NASDAQ 100, mutual funds (e.g., like those offered in a 401(k) plan), and company stock. The referenced funds can be, but are not limited to, any one or a combination of funds, indexes and interest-based investments.

In step 305, at the end of a particular monitoring period (e.g., daily, weekly, monthly or quarterly), the liability of the plan sponsor is determined based on a present notional value of the referenced funds. As would be appreciated by one of ordinary skill, a plan sponsor could even allow a plan participant to manage its referenced funds in real-time.

In step 310, the system 50 also accounts for additions to the referenced funds corresponding to the plan participants in the latest monitoring period. Additions include, but are not limited to, additional deferrals, company matches and/or dividends or distributions corresponding to the referenced funds.

In step 320, the system 50 also accounts for reductions in the referenced funds of the plan participants in the latest monitoring period. Such reductions include, but are not limited to, payouts to the plan participants and forfeitures. Forfeitures can include penalties and reductions in hypothetical account balances for changes in the payout bucket or plan's payout conditions (e.g., a 10% forfeiture resulting from a request to change a payout date from 65 to 60 years old).

In step 325, the system 50 also accounts for any changes in asset allocation during the latest monitoring period. For example, if a plan participant moved $1,000 of deferred compensation from referenced fund X to referenced fund Y on a particular date, then the referenced funds need to reflect that change.

In step 330, the system 50 also reports to the plan participants (and the plan sponsor) the results of the changes in value of referenced funds, as well as the additions, reductions and changes in allocations of the referenced funds. Eventually, the whole process starts again at step 305.

On the asset-side, the administration system 50 tracks, reconciles and administers the values, at the plan participant payout bucket level, of the targeted investments, at least some of which are subject to hedging transactions. The functions of the administration system 50 can be broken down into at least three general types of administration functions: (1) hedging transaction initialization, (2) ongoing hedging transaction administration, and (3) settlement administration.

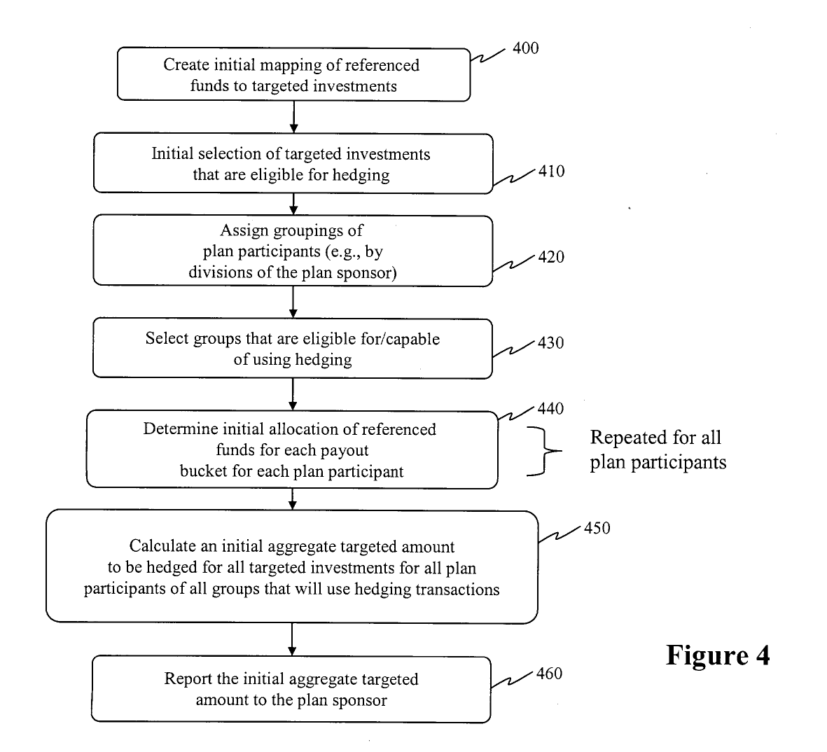

FIG. 4 represents a general overview of the hedging transaction initialization process. In step 400, the plan sponsor selects the initial mappings of a set of referenced funds to plural targeted investments as they are to be tracked in the system 50. (The set of referenced funds that are mapped to targeted investments is either all the referenced funds or a sub-set of the referenced funds. That is, as described hereafter, not all referenced funds need be mapped to a targeted investment.) These initial mappings are communicated to the administration system 50. In step 410, the targeted investments that are eligible for hedging are identified by the plan sponsor and communicated to the administration system 50. However, as discussed below, not all targeted investments that are eligible for hedging are actually hedged. The decision to utilize a hedging transaction may be based on a number of factors (e.g., whether the plan participant is in a group that allows hedging transactions, what the cost of hedging transactions currently is, or the feasibility of selecting a targeted investment to efficiently manage, with a hedging transaction, the exposure represented by a particular referenced fund at the aggregate level of the targeted investment).

In step 420, plan participants are divided into groups (e.g., divisions within a company that have separate profit and loss statements). Such groups may also occur because of tax, regulatory or insurance issues.

In step 430, the groups of participants that are eligible for hedging transactions are identified by the plan sponsor and communicated to the administration system 50. This initial identification, however, does not preclude a plan sponsor from later deciding to stop hedging transactions for a particular group. Conversely, a group that is initially not eligible for hedging transaction may later be identified by a plan sponsor as eligible for hedging transactions (e.g., if the assets of the group reach a threshold specified by the plan sponsor).

Once the rules for utilizing hedging transactions have been established, then the system 50 begins to determine an aggregate amount that will be subject to the hedging transaction. In step 440, the allocations and values of the referenced funds are determined for each payout bucket for each plan participant, and those referenced funds are mapped to targeted investments that are eligible for hedging, thus establishing the values for the “mini-hedge” that corresponds to each payout bucket. From that, in step 450, the system calculates the initial aggregate amount that will be subject to the hedging transaction for all targeted investments that are eligible for hedging for all plan participants belonging to groups that will utilize hedging transactions. In step 460, the initial aggregate amount to be hedged and the aggregate for each targeted investment to be hedged as calculated by the system 50 is reported to the plan sponsor. The system 50 may also report the aggregate amount to the counter-party.

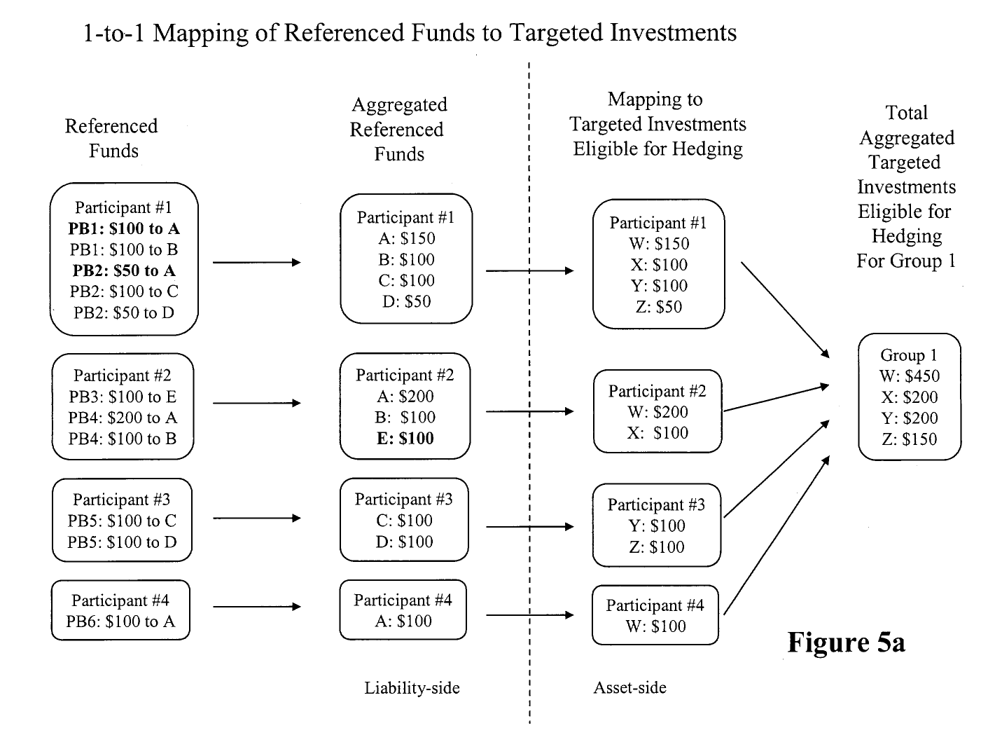

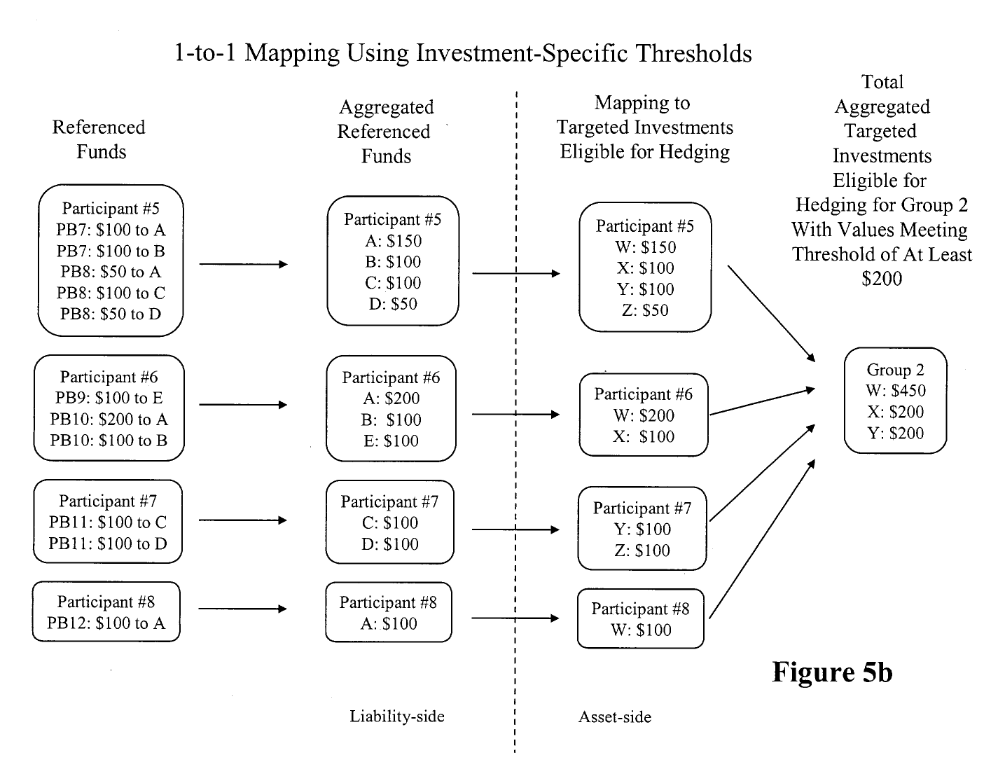

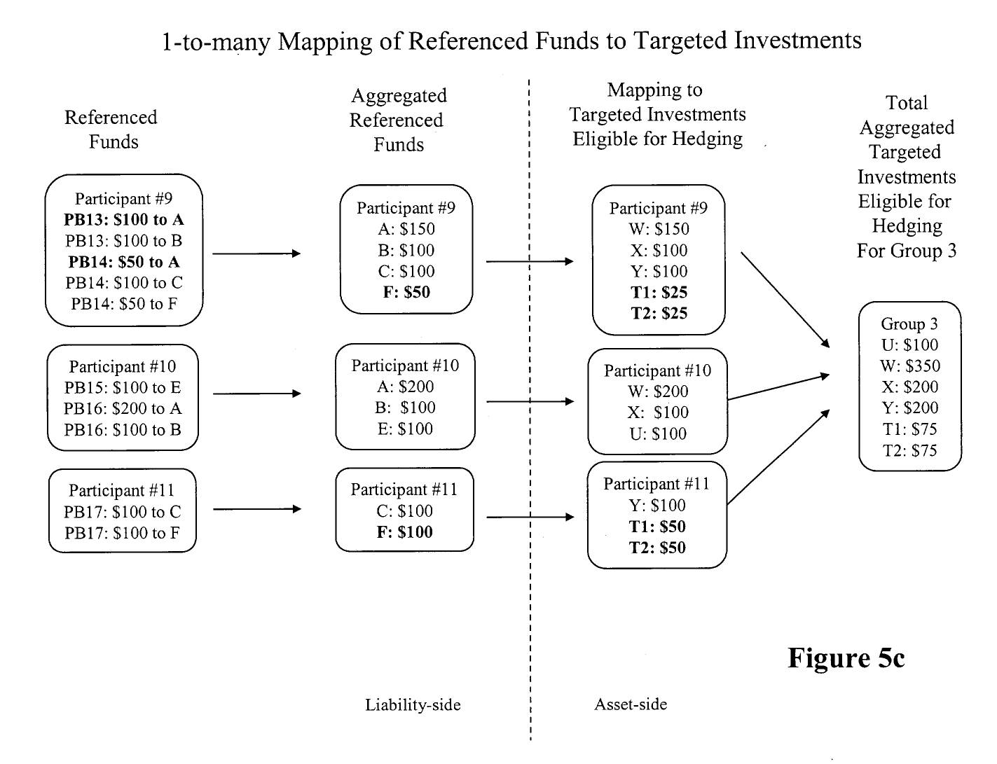

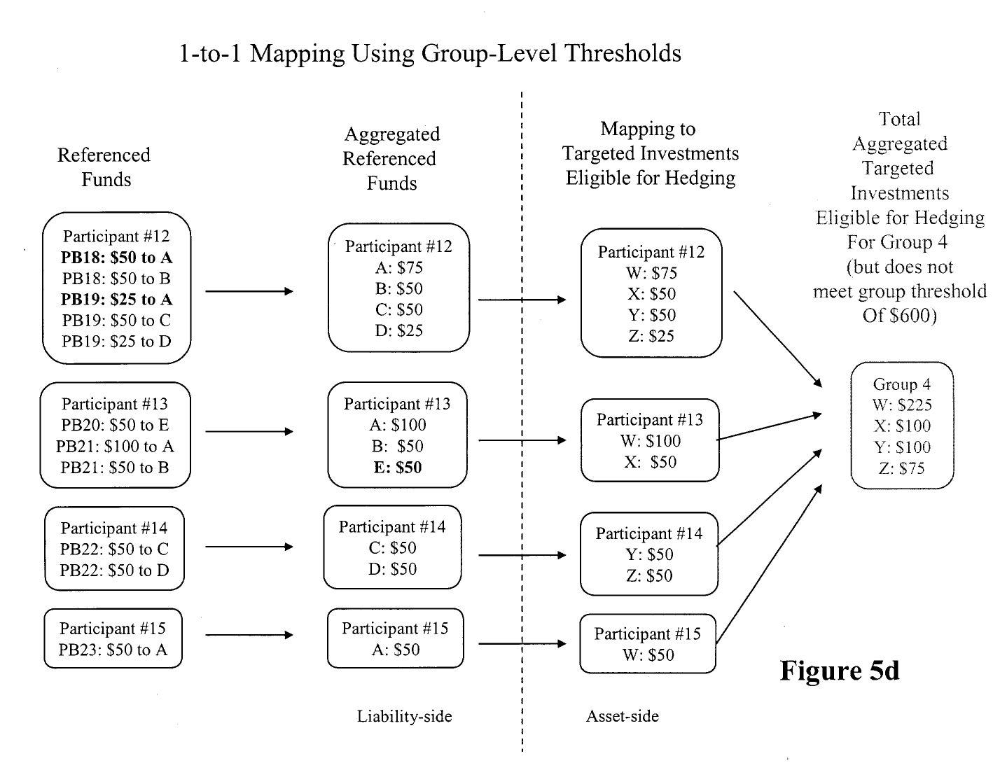

FIGS. 5a-5d provide examples of the aggregation portion of the initialization process of FIG. 4. FIGS. 5a-5d assume that the plan sponsor has already communicated to the administration system 50 what the initial mappings from referenced funds to targeted investments are as well as the mapping of participants to groups and what groups are eligible for hedging transactions (and any dynamic rules for determining if a group should be eligible for hedging transactions). Having communicated that information to the administration system 50, generally, targeted investments within each mini-hedge are aggregated “up” by grouping together like targeted investments of mini-hedges within the same group. Those targeted investments are then treated like a block.

For example, as shown in FIG. 5a, there is an initial mapping of referenced funds to targeted investments. In FIG. 5a, four participants (participants 1-4) each have made at least one deferral. The deferrals are separated by payout buckets (labeled PB1, PB2, and PB3). The payout buckets could correspond to, but are not limited to, payouts to coincide with retirement or educational expenses for children. The payout buckets may also have additional vesting or payout conditions that are specified by the plan sponsor, such as requiring that a plan participant remain employed a certain number of years before the investments vest in the participant or before the participant can starting collecting the benefits.

As illustrated therein, there are two payout buckets for plan Participant #1 (PP 1), two payout buckets for plan Participant #2 (PP2), one payout bucket for plan Participant #3 (PP3), and one payout bucket for plan Participant #4 (PP4). It should be noted that the different payout buckets generally have payouts at different times and under different conditions. For example, if PB1 is intended to provide funds upon retirement, a 45 year old participant would not be entitled to a payout on that investment for another 20 years (e.g., assuming retirement at age 65). However, if PB2 is intended to provide funds for educational expenses for a first child that is going to college in five years, then the benefits of that payout bucket will be paid out much sooner. Also, when the NQDC benefits (i.e., payout buckets) are paid out, they can be paid out in very different forms (e.g., monthly, quarterly, yearly or lump sums).

As shown with respect to PP1, PP1's first payout bucket is PB1, and it is initially configured to have two referenced funds (A and B). PP1's second payout bucket is initially configured to have three referenced funds (A, C and D). As further shown with respect to Participant #1, investments in referenced fund A ($100 in PB1 and $50 in PB2) can be combined (to create a single $150 investment) when creating aggregated referenced fund values for Participant #1. That is, PP1 has an initially deferred amount of $150 in PB1 split between two referenced funds.

Based on the mappings initially specified by the plan sponsor, PP1's five referenced funds in two payout buckets are combined and cause the administration system 50 to allocate to four targeted investments (W. X, Y, and Z). Based on the mappings initially specified by the plan sponsor, all four of those targeted investments are eligible for hedging.

Similarly, PP2 has an initially deferred amount of $400 into two payout buckets (PB3 and PB4), but the deferral for referenced fund E has been specified by the plan sponsor as not being eligible for hedging. Thus, the administration system 50 elects to allocate to only two targeted investments (W and X). Similar mappings for plan participants #3 and #4 (PP3 and PP4) result in additional initial allocations to targeted investments, all of which are eligible for hedging.

FIG. 5a assumes that those four plan participants (PP 1-PP4) are the only participants in Group #1. As a result, the administration system 50 then performs a group-level aggregation. The administration system 50 determines that four targeted investments that are eligible for hedging are used within the group. It also determines the amounts that are eligible for hedging in each targeted investment in aggregate.

FIG. 5b shows a second group (i.e., Group #2) of plan participants (PP5-PP8) which make allocations similar to those of Group #1. In this group, however, the plan sponsor has specified that it is inefficient to utilize hedging transactions for aggregated targeted investments below a threshold of $200.

FIG. 5b assumes that those four plan participants (PP5-PP8) are the only participants in Group #2. As a result, the administration system 50 then performs a group-level aggregation for Group #2 as shown. The administration system 50 determines that four targeted investments used within the group are eligible for hedging. It also determines the amounts that are eligible for hedging in each targeted investment. However, since the aggregate of investment Z is below $200, the investment in Z is not subject to a hedging transaction.

FIG. 5c shows a third group (i.e., Group #3) of plan participants (PP9-PP11) and their initial allocations. In this group, however, the plan sponsor has specified that certain referenced funds will initially be mapped to two different targeted investments. FIG. 5c illustrates that referenced fund F is one such investment, and it causes the administration system 50 to allocate half of the deferrals in F into T1 and the other half into T2. Both T1 and T2 are eligible for hedging.

FIG. 5c also shows that a plan sponsor can elect to hedge a targeted investment in one group without electing to hedge it in all groups. PP10 has elected to invest in referenced fund E, and the administration system 50 initially maps this to targeted investment U. This is in direct contrast to the investment of PP2 in referenced fund E which the plan sponsor had elected to make ineligible for hedging. Such a group-specific choice may occur because of regulatory, tax or insurance reasons.

FIG. 5c assumes that those three plan participants (PP9-PP1 1) are the only participants in Group #3. As a result, the administration system 50 then performs a group-level aggregation for Group #3 as shown. The administration system 50 determines that six targeted investments are used within the group that are eligible for hedging. It also determines the amounts that are eligible for hedging in each targeted investment in the aggregate.

FIG. 5d shows the last group (i.e., Group #4) which has four plan participants (PP12-PP15) who make the exact same types of deferrals as PP1-PP4, but at half of the deferral values. The initial mappings of referenced funds to targeted investments is also the same in Groups #1 and #4, so the group-level aggregate for Group #4 is the half of the group-level aggregate for Group #1. Because the group level threshold of $600 is not met for Group #4, the administration system 50 determines that the aggregated targeted investments for Group #4 will not be subject to a hedging transaction.

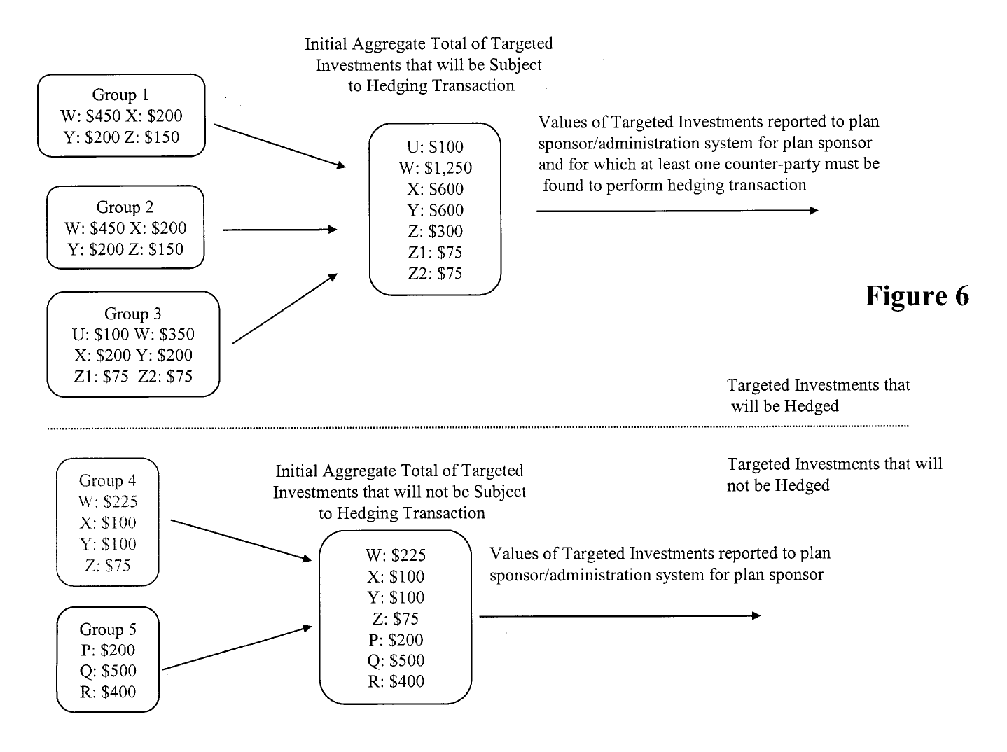

Turning now to FIG. 6, the process of step 450 (FIG. 4) is performed by the system 50 to determine the initial aggregate total of targeted investments that will be used for purposes of establishing the qualifying hedging transaction. FIG. 6 assumes that the plan sponsor has elected to allow the targeted investments that are eligible for hedging in Groups #1-4 to be hedged, but has elected to never utilize hedging transactions for Group #5. However, the plan sponsor has also specified a threshold ($600 in this example) under which the targeted investments of Group #4 will not be subject to a qualifying hedging transaction. That is, even though the referenced funds of Group #4 have been mapped to targeted investments that are eligible for hedging, they are not actually subject to a qualifying hedging transaction because of a group-wide override. Such an override may occur for any of a number of reasons that a plan sponsor may specify. Such an override may occur, for example, because an aggregate amount in the targeted investments of a group is above or below a threshold specified by the plan sponsor. The example of FIG. 6 assumes that groups that have an aggregate targeted value of less than $600 are not hedged. Thus, Groups #1-3 which all have aggregate targeted investments greater than $600 are subject to a qualifying hedging transaction, whereas Group #4 is not.

Similarly, an override may occur if a number of plan participants is above or below a specified threshold. As can be seen from both of the types of overrides, the decision to include or exclude participants of a group in calculating an amount to be subject to a hedging transaction can be made dynamically at the time of the aggregation. (In the case of Group #4, only $100 more would need to be deferred before the targeted investments of Group #4 would be subject to a hedging transaction as well.) The decision can also be set statically by the plan sponsor instead.

Since Groups #1-3 are to be hedged, the administration system 50 aggregates their targeted investments that are eligible for hedging and determines the initial aggregate value for seven targeted investments. This initial value is communicated to the plan sponsor by the administration system 50 and may also be communicated to the hedging transaction counter-party. This aggregate is the amount that forms the basis of the qualifying hedging transaction with the counter-party. The system 50 need only establish that the qualifying hedging transaction has been completed (or will be completed) between the plan sponsor and the counter-party. The system 50 need not actually control or be a party to the transaction, although it can.

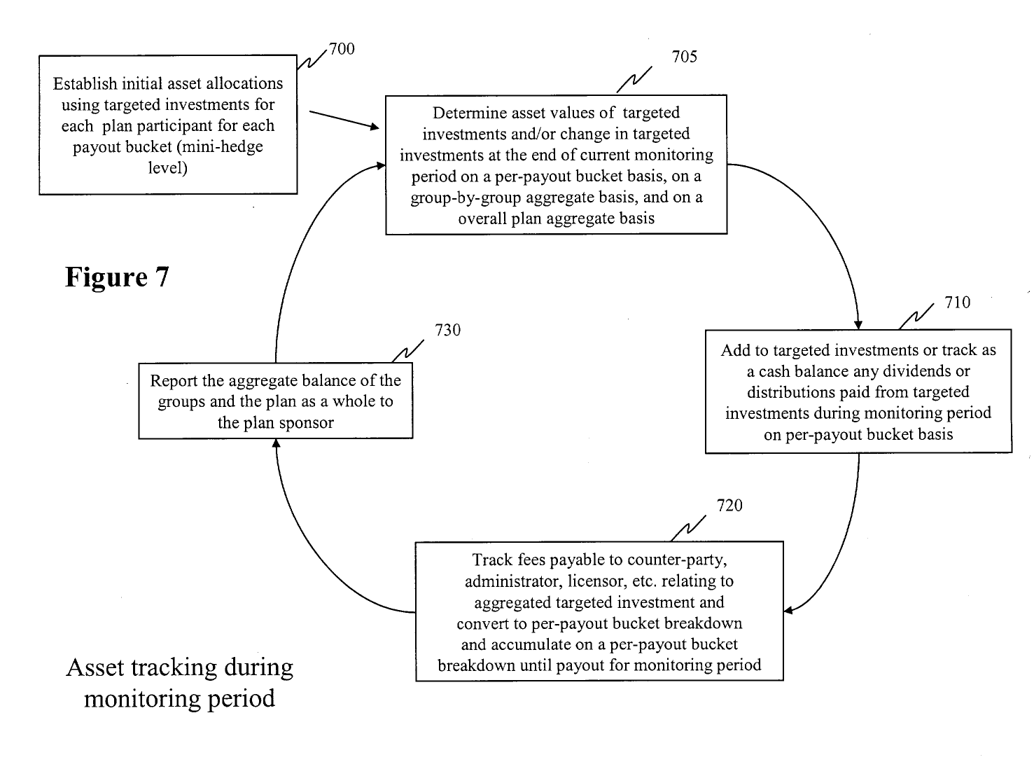

Turning now to the asset-side tracking of the present invention, FIG. 7 illustrates a flowchart of asset-side tracking during a monitoring period. The monitoring period is specified by the plan sponsor, and is either variable or fixed. Typically, the monitoring period is one trading day such that the asset values of the targeted investments are tracked at the end of each trading day. However, other monitoring periods such as a week, a month, a quarter and a year are possible as well as real-time tracking.

As shown in step 700, an administration system 50 establishes an initial asset-side allocation using the targeted investments that were mapped from a plan participant's referenced fund selections and that were eligible for hedging. The system may track this initial allocation as either an absolute dollar amount or as a number of shares of the corresponding targeted investment at its current share price. By tracking the number of shares of each of the targeted investments, the administration system 50 can easily determine a total value for the targeted investments for each of the plan participants. This step assumes that the initial asset allocations of the targeted investments have been hedged pursuant to a hedging transaction with a counter-party. The types of hedging transactions that are possible with a counter-party are discussed in greater detail above.

In step 705, at the end of a monitoring period (e.g., at the end of a trading day), the administration system 50 determines a new set of values corresponding to the targeted investments that are used to manage the exposure to liabilities to the plan participants. When share-based tracking is used, the administration system 50 can simply contact the appropriate information sources to determine the final price or value of each of the different types of targeted investments held by the plan sponsor and multiply by the number of corresponding shares. The administration system 50 can communicate with the information sources using any one, or a combination of, direct dial communications (e.g., modem or facsimile), local area network communications and wide area (e.g., Internet) communications.

Having determined the final values of the various targeted investments, the administration system 50 determines the mini-hedge value that corresponds to each payout bucket for each plan participant as well as a value of all mini-hedges corresponding to each group and on an overall plan aggregate basis.

In step 710, the administration system 50 determines if any dividends/distributions have been paid with respect to any of the targeted investments. If so, the system can track at least any one of (1) paying out the dividend/distribution immediately, (2) carrying that dividend/distribution value forward as additional cash value corresponding to the targeted investment, (3) reinvesting the dividend/distribution in the underlying targeted investment and increase the number of shares in the underlying targeted investment by a corresponding amount, or (4) reinvesting the dividend/distribution in any other targeted investment (as designated by agreement of the plan sponsor and the counter-party) and increase the number of shares in such designated targeted investment by a corresponding amount. In any of these ways, the administration system 50 is capable of tracking the additional value corresponding to the dividend/distribution.

In step 720, the administration system 50 also tracks any fees that the plan sponsor may owe because of the hedging transaction or the management thereof. For example, the plan sponsor may owe to a counter-party an interest-based payment representing a percentage (e.g., LIBOR+a spread) of the value of the initial aggregate value of the targeted investments used for purposes of the hedging transaction. The counter-party's percentage fee may be charged as an outright fee or may be incorporated into the structure of the hedging transaction. For example, an equivalent adjustment to the forward price or the strike price for puts and calls could be made to compensate the counter-party. In this example the equivalent adjustment could be calculated to equal product A times B times C, where A equals the percentage fee payable to the counter-party, B equals the initial aggregate value of the targeted investment, and C equals the quotient of the number of days from commencement of the hedging transaction until settlement divided by the number of days in a year. The plan sponsor may also owe fees to the party providing the administration system 50 or providing other licensed technology that enables or supports the administration system 50. For any of such fees that are incurred, the administration system 50 can attribute a pro rata share to the mini-hedge that corresponds to each payout bucket. For example, assuming that $100/day was attributable to fees for targeted investments that were the subject of a hedging transaction, the administration system 50 could determine what portion of that $100/day corresponds to the mini-hedge value of each payout bucket. If the value of the targeted investments mapped from PP1's PB1 account represented 1/1000th of the total value of the targeted investments that were the subject of a hedging transaction, then the administration system 50 would attribute to PP1's PB1 account (on the asset-side) a charge of $0.10 for the day. This is not to say that the value of PP1's PB1 account on the liability side is decreased by $0.10. The cost of providing the hedging transaction involving the targeted investments is invisible to and decoupled from the contractual liability of the plan sponsor to the plan participant (who may not know or care how or if the plan sponsor is utilizing hedging transactions involving targeted investments). This charge is accumulated with any other earlier charges as a deferred deduction to be used by the plan sponsor when PP1 receives a distribution corresponding to PB1. If the hedging transaction or any particular fees, charges, etc. do not qualify under the special hedging rules for deferral of values, then these amounts are reported to the plan sponsor for possible deduction in the current tax year.

In step 730, the administration system 50 reports the aggregate balance of the targeted investments to the plan sponsor on a group-by-group basis and/or on a whole plan basis. The process then begins again with the next monitoring period.

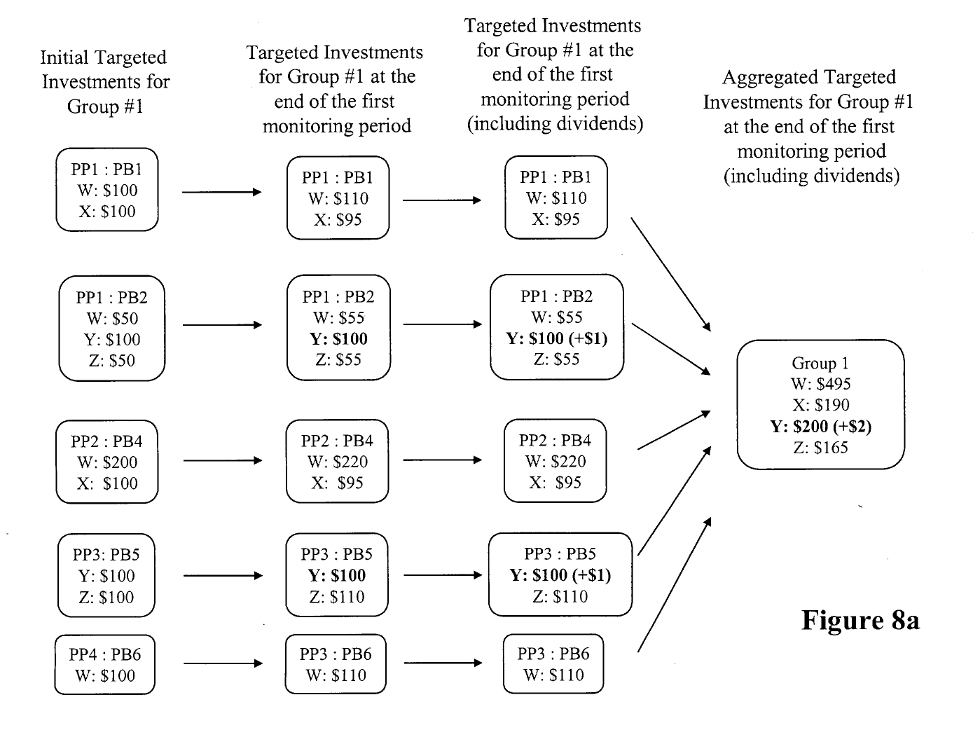

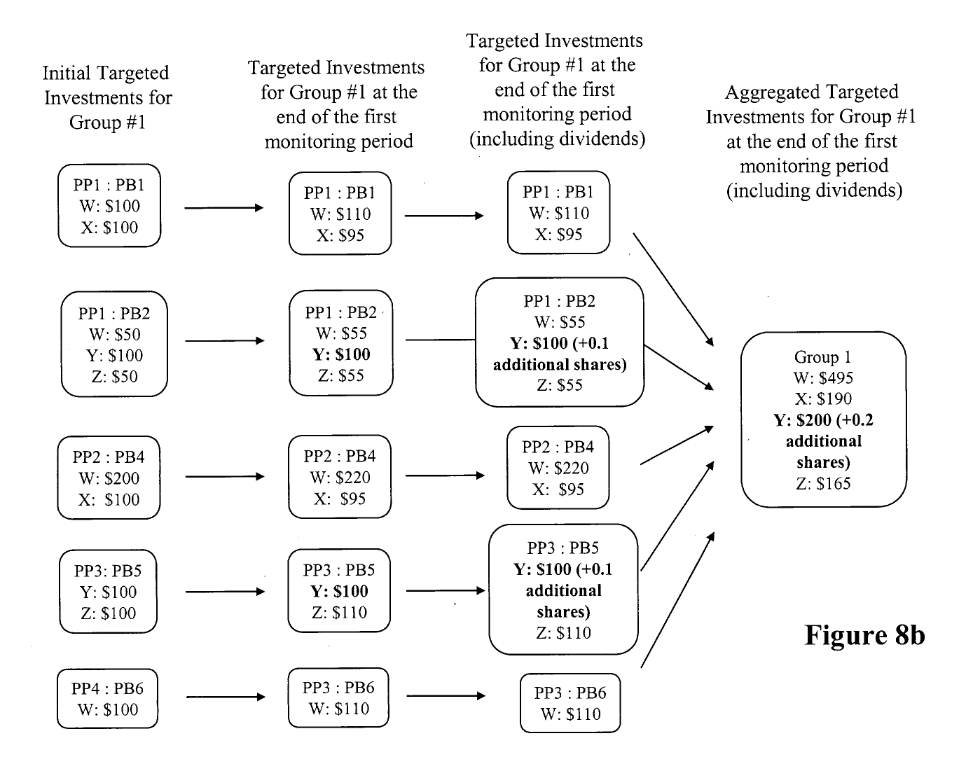

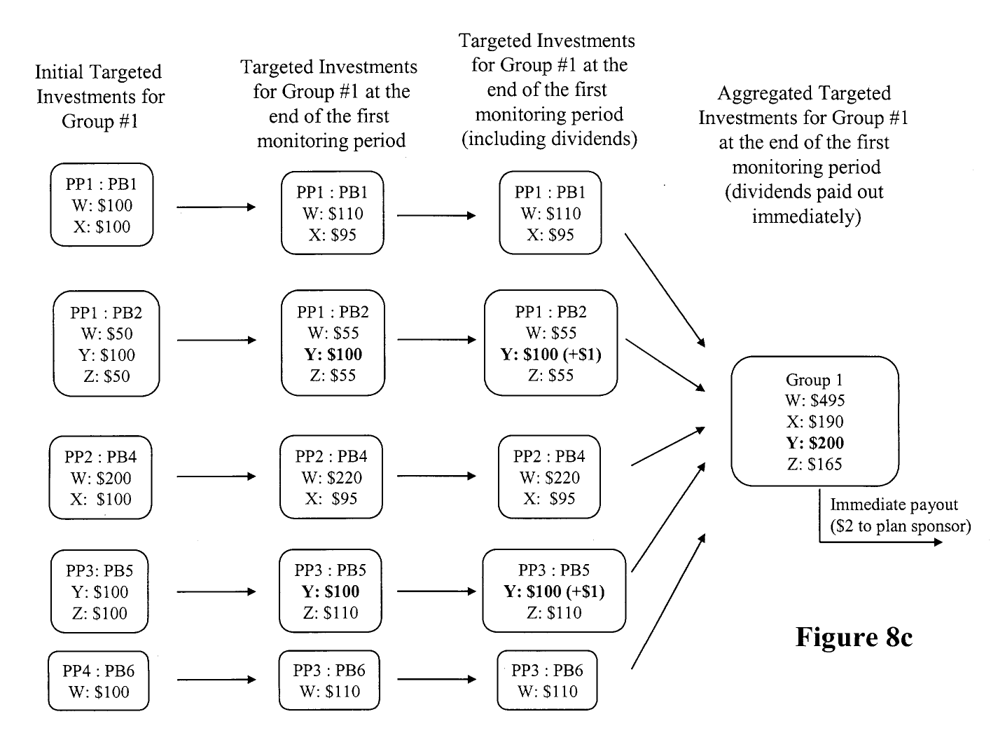

As shown in FIG. 8a, the initial targeted investments of group #1 are tracked on a per-payout bucket basis (corresponding to step 700 of FIG. 7). The two payout buckets (PB1 and PB2) of PP1 are separately tracked for tax deferral purposes. Initially the plan sponsor has allocated $200 in targeted investments W and X for purposes of the hedging transaction to cover the plan sponsor's liabilities for PP1's PB1 account. Similarly, initially the plan sponsor has allocated $200 in targeted investments W, Y and Z for purposes of the hedging transaction to cover the plan sponsor's liabilities for PP1's PB2 account.

At the end of the first monitoring period (corresponding to step 705 of FIG. 7), the administration system 50 determines that the targeted investments corresponding to PB1 are worth $205 and the investments in PB2 are worth $210. Thus, the system has identified a $5 and a $10 increase, respectively, in the values of the targeted investments to which the liabilities of PB1 and PB2 accounts were allocated for purposes of the hedging transaction on the asset-side. (It should be noted that, on the liability side, the referenced funds may have increased, decreased, or stayed the same, but the returns on the referenced funds remain independent (or decoupled) from the returns on the targeted investments or the results of the hedging transaction.)

The administration system 50 then determines that the investment Y was subject to a dividend of $1. Both PP1 and PP3 have targeted investments in Y, and for the examples of FIGS. 8a and 8b, it is assumed that the targeted investment Y of PP1 and PP3 represents one share. Using the monitoring process of FIG. 8a, the administration system 50 adds to the value of the targeted investment Y an additional $1 cash value for each of the targeted investment Y allocations to PP 1 and PP3. Alternatively, the monitoring process of FIG. 8b simply reinvests the dividend in the targeted investment Y and increases the number of shares by 0.1 (assumes a $10 share price) for each share of targeted investment Y allocated to PP1 and PP3.

The processes shown in FIGS. 8a and 8b are then repeated for the other payout buckets for the other groups. The aggregated targeted investment values are then communicated to the plan sponsor and may also be communicated to the hedging transaction counter-party. For example, the Group #1 values of $495, $190, $200 and $165 are communicated to the plan sponsor for targeted investments W, X, Y and Z respectively. The dividend value of $2 corresponding to targeted investment Y is also communicated to the plan sponsor/counter-party. (The administration system 50 may choose to communicate the dividend value to the plan sponsor as part of the value of targeted investment Y, such that the administration system 50 communicates the group value corresponding to targeted investment Y at $202 instead of $200.)

Similar to the process described in FIGS. 8a and 8b, it is also possible to track payouts between a counter-party and the plan sponsor in which the counter-party pays to the plan sponsor the dividend or distribution without carrying the distribution or dividend to settlement and without re-investing the distribution or dividend. The payout may be made either immediately (e.g., on the same or the next business day after the distribution or dividend is paid out) or anytime (e.g., a few days) after the distribution or dividend is paid out but before the end of the settlement period.

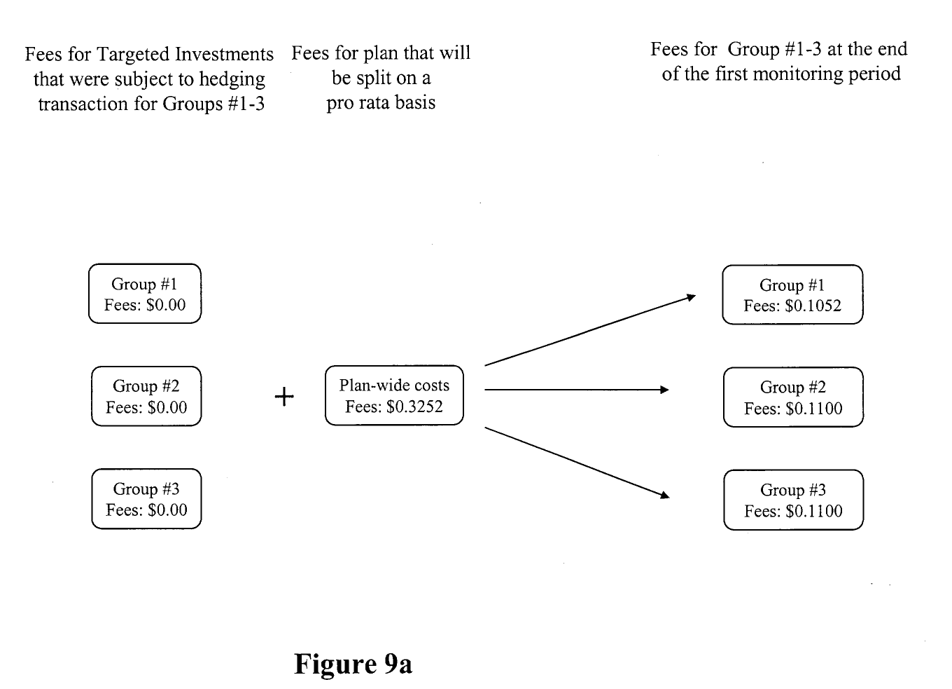

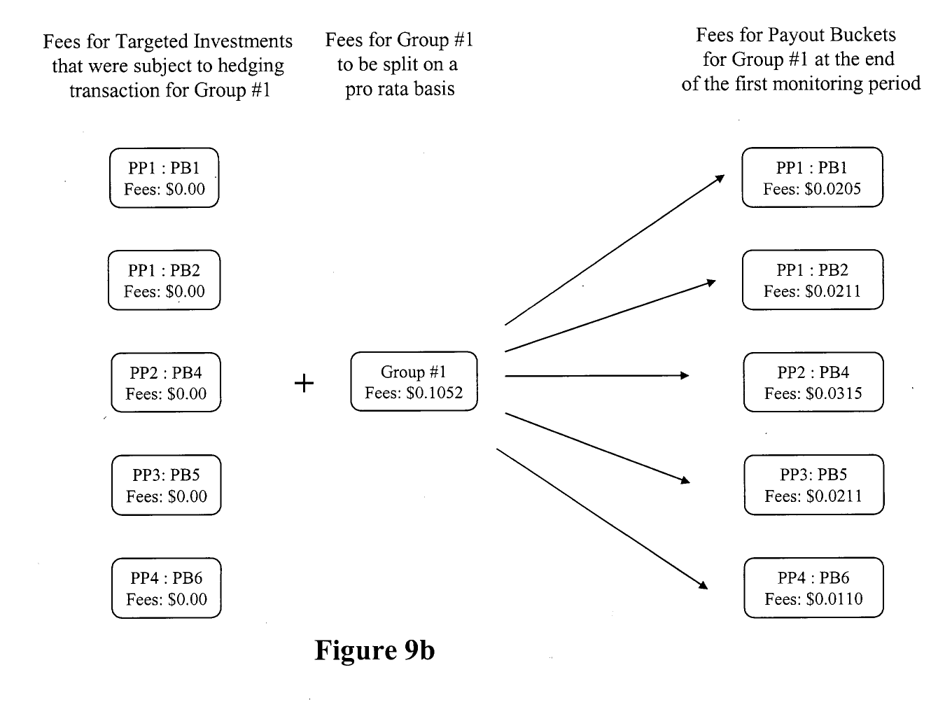

Turning now to FIG. 9a, the determination and aggregation of fees at the plan level is converted for tax deferral purposes to fees at the group level. While the fees for the counter-party, administration, licensing and other costs can be negotiated in any number of fashions, the example of FIG. 9a assumes that the total fee per monitoring period is $1/10,000 per dollar that is subject to the hedging transaction at the end of the monitoring period. Assuming at the end of the first monitoring period there is $3,252 dollars that are subject to the hedging transaction in aggregate, the overall fee is $0.3252. With respect to Group #1, since at the end of the first monitoring period there is $1,052 dollars that are subject to the hedging transaction (see FIGS. 8a and 8b), the group-based fee is $0.1052. Assuming that Groups #2 and #3 both increased by ten percent over their initial values, their total values are both $1,100. Thus, with respect to Groups #2 and #3, since at the end of the first monitoring period there is $1,100 each that are subject to the hedging transaction, the group-based fees for each is $0.1100. Such a fee allocation method is only an example of one type of fee allocation method, and numerous other methods are encompassed within the present invention. For example, a fee may be based on a total number of participants in a group or plan.

Turning now to FIG. 9b, the partition of Group #1's fee attributable to the mini-hedges that correspond to Group #1's payout buckets is illustrated. Dividing the aggregate fee into each mini-hedge that corresponds to each payout bucket causes each mini-hedge to be assessed its corresponding fee on the asset side.

While FIGS. 9a and 9b illustrate a process of “pushing down” fees from a plan level to a group level to a mini-hedge payout bucket level, it is possible to roll-up the accumulation of costs as well. Examples of fees that can be rolled up are fees based on a participant's longevity in a plan. For example, fees may be charged at a higher rate to new participants, and at a decreasing rate to participants who have been in the plan for a longer period of time. Similarly, there may be a fee charged to the plan sponsor for each reallocation by a plan participant. Such changes may be allocated to the mini-hedge that corresponds to the payout-bucket on behalf of which a change is being made. Fees based on a percentage, such as the examples used in FIGS. 9a and 9b, could also be assessed at the payout bucket level first, and then rolled up.

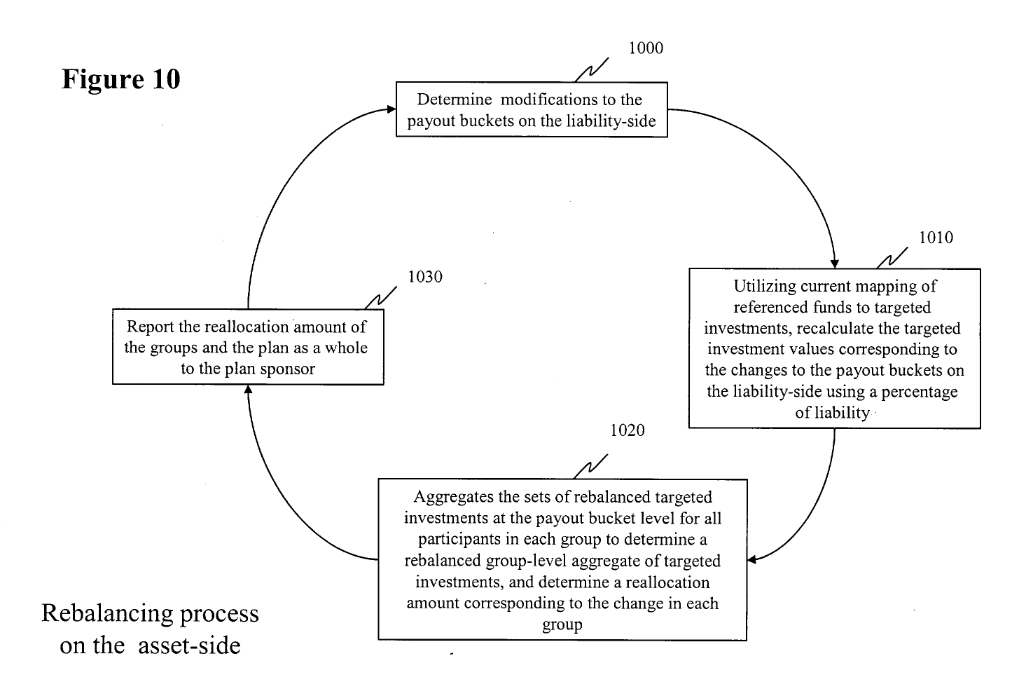

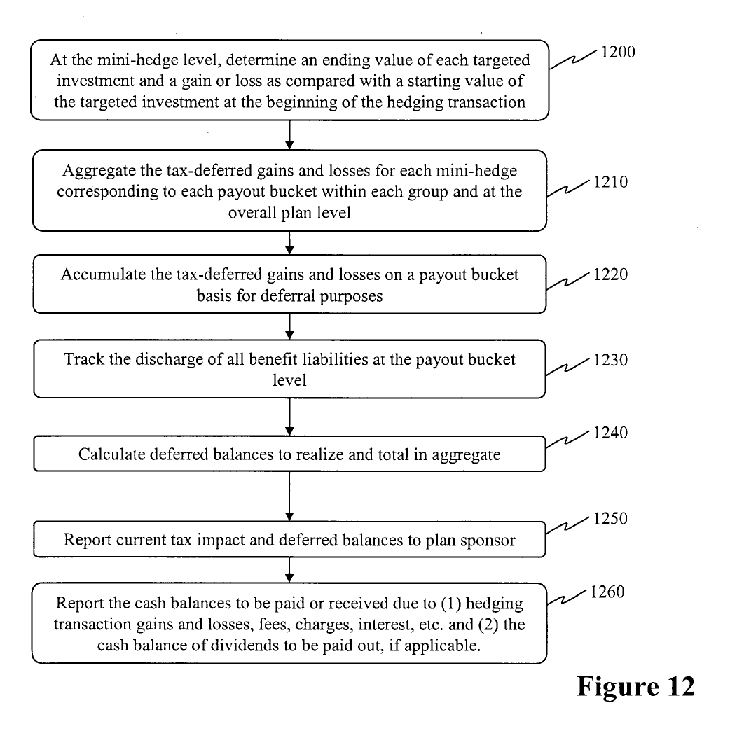

Turning now to FIG. 10, a process of rebalancing referenced funds and targeted investments is described. This process occurs once a rebalancing period, which can be any period specified by the plan sponsor (e.g., once a day, week, month, quarter, year, etc.). This process allows changes in the allocations of, and additions and reductions to, referenced funds of the plan participants to be matched to new allocations of targeted investments by the plan sponsor and the counter-party. The rebalancing may also occur because of other reductions. This may require a change in the allocations to targeted investments by the plan sponsor (and by the counterparty), but any cash settlements between the plan sponsor and the counter-party with respect to the hedging transaction are delayed until settlement time (described with reference to FIG. 12).

In step 1000, the administration system 50 determines that at least one plan participant has made a change in allocation, or other additions or reductions have occurred, on the liability side. In response, the administration system 50 analyzes the existing allocation of targeted investments as they relate to the new allocation of referenced funds.

In step 1010, using a percentage of the liability, the system calculates an equivalent set of targeted investments at the mini-hedge level for each payout bucket that corresponds to the new allocation of referenced funds:

Sub-step a—The system calculates the value of the liabilities represented by each referenced fund in the payout bucket as of the rebalancing date and the corresponding percentage of liability for each referenced fund as compared to the total value of all referenced funds in the payout bucket

Sub-step b—The system determines the new set of targeted investments that are eligible for hedging that correspond to each referenced fund in the payout bucket as of the rebalancing date

Sub-step c—The system calculates the aggregate values of targeted investments in the payout bucket on the asset-side that were subject to the hedging transaction as of the rebalancing date

Sub-step d—The system allocates the aggregate values determined in Sub-step c to the targeted investments determined in Sub-step b using the percentages determined in Sub-step a.

In step 1020, the system aggregates the sets of rebalanced targeted investments at the payout bucket level for all participants in each group to determine a rebalanced group-level aggregate of targeted investments and a rebalanced overall aggregate of targeted investments. These rebalanced groups and overall level aggregate of targeted investments are compared to a previous group and overall level aggregate of targeted investments so that the system can determine a reallocation amount for each targeted investment at the group level and the overall level. In step 1030, the system communicates these reallocation amounts for each targeted investment within each group to the plan sponsor and may also communicate this information to the counter-party.

The system may utilize certain triggering mechanisms to determine whether the rebalancing process results in an actual rebalancing of targeted investments that are subject to the hedging transaction. These triggering mechanisms may include, without limitation, approval by the plan sponsor and/or the counter-party, or minimum and/or maximum thresholds with respect to the percentage or absolute dollar amount of change in one or more targeted investments or in the aggregate. For example, a percentage threshold may be ±10%, such that if liabilities due to referenced fund A change more than 10% with respect to targeted investment W (to which referenced fund A is mapped), then rebalancing will occur. Such triggering mechanisms will be determined by the terms of the hedging transaction and therefore could have any number of possibilities.

If the triggering mechanisms for rebalancing are satisfied, the system will make changes according to the reallocation amounts for purposes of tracking values after the rebalancing date at the mini-hedge level that corresponds to each payout bucket and at the group and overall aggregate level.

This reallocation process may result in the counter-party rebalancing its holdings to be in line with the new allocations of targeted investments by the plan sponsor.

The system may also utilize certain default targeted investments (which may be represented, for example, by a money market account) or other methods specified by the hedging transaction agreement for purposes of allocations by a plan participant into or out of a referenced fund for which the corresponding targeted investment is not eligible for hedging or to take into account reductions in the payout bucket on the liability side (e.g., because of benefit payouts or forfeitures) between settlement dates. Such methods will be determined by the terms of the hedging transaction and therefore could have any number of possibilities.

As used herein, the rebalancing process may be performed at any one level, or at a combination of levels. For example, the reallocation of referenced funds may cause the system to look at the allocations for the plan participant across multiple payout buckets, but without looking at more than one plan participant. Similarly, the system may attempt to aggregate changes among plural participants in a single group. Also, the system may try to aggregate changes across multiple groups.

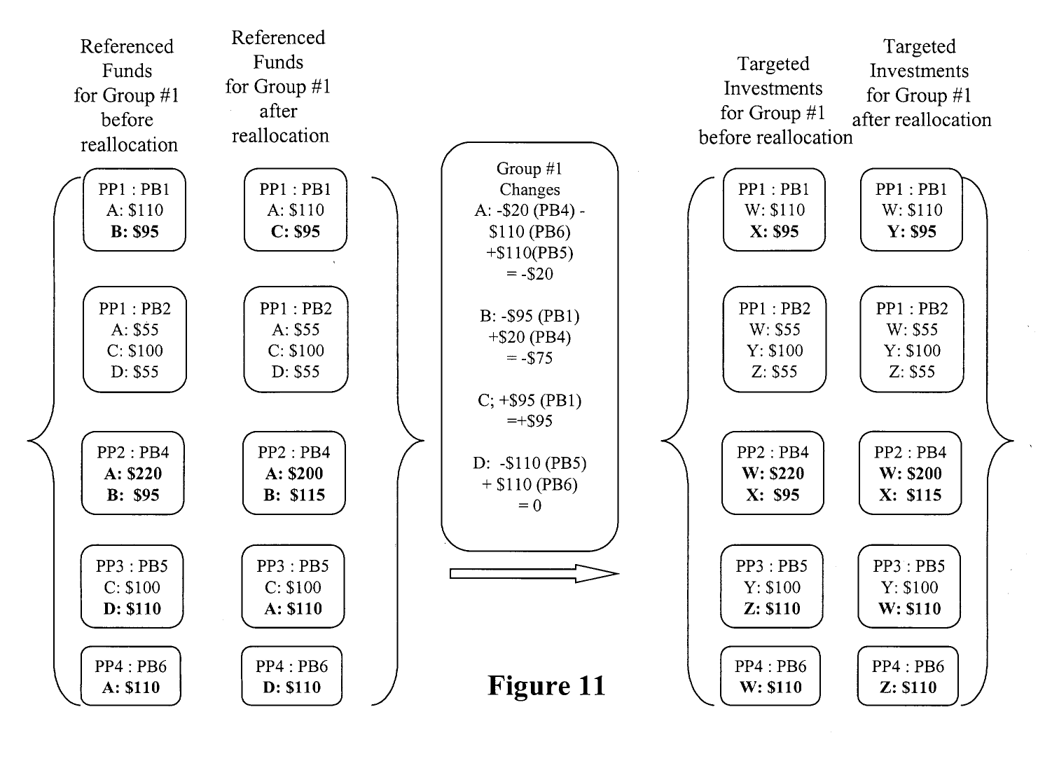

FIG. 11 illustrates changes in the referenced funds for PP1:PB1, PP2: PB4, PP3:PB5 and PP3:PB6 and corresponding rebalancings where the system identifies that rebalancing is necessary. (It should be noted that the one-to-one correspondence in dollar amounts between referenced funds and targeted investments is for illustrative purposes only, and in practice it would be very unusual to find such a correspondence.)

In FIG. 11, PP1 has elected to reallocate its previous deferral in referenced fund B to referenced fund C. PP2 has elected to move $20 from referenced fund A to referenced fund B. PP3 has elected to move $110 from referenced fund D to referenced fund A. In the same period, PP4 has elected to move $110 from referenced fund A to referenced fund D.

By aggregating the changes, the amount hypothetically invested in referenced fund A is reduced by $20, the amount hypothetically invested in referenced fund B is reduced by $75, and the amount hypothetically invested in referenced fund C is increased by $95. Using the current mappings of referenced funds to targeted funds, the targeted investments corresponding to the changed payout buckets are updated.

By aggregating the changes in the targeted investments, a mismatch between the plan sponsor's current allocations to targeted investments and the plan participants' current referenced funds can be determined. Since the changed amounts are small, however, no actual rebalancing is caused. Conversely, the changes in funds A, B and C could cause the need for rebalancing.

As described above, the targeted investments are decoupled from the referenced funds. The targeted investments are also further decoupled from the hedging transactions that control the relationship between the plan sponsor and the counter-party. Targeted investments can be bought and sold by the counter-party in response to rebalancing calculations. As those targeted investments are sold, it is not necessary for cash to transfer between the plan sponsor and the counter-party. Which ever side obtains cash from the hedging transactions is determined by the terms of the hedging transactions at the time that a settlement period ends, as described in greater detail below.

The system 50 also controls a settlement process that can occur at the end of the time period specified in the hedging transaction (e.g., monthly, quarterly, half-yearly, or yearly) and that time period is referred to herein as the “settlement period.” It should be noted that the administration system 50 may support (and the plan sponsor may negotiate) settlement periods that are different for different liabilities to be hedged. (It is also noteworthy that using relatively short settlement periods ensures that a counter-party pays the plan sponsor relatively soon, or vice versa, when large fluctuations in the value of the targeted investments have occurred. This is important if the financial condition of one of the parties comes into question while a hedging transaction is in place. Extreme financial difficulty of either party may cause a pre-mature contract termination and settlement process.) The system 50 may either actually act as a facilitator for money to be transferred during the settlement process, or the system 50 may simply report to the plan sponsor and the counter-party the amount and direction of the settlement for the settlement period. The system may also receive information from the plan sponsor and/or the counter-party regarding the results of the hedging transaction and reconcile and report to the plan sponsor and/or the counter-party the results of the hedging transaction for the system.

At the end each settlement period, the plan sponsor and the counter-party exchange the necessary funds to meet their contractual obligations. For example, using a forward contract, if the value of the aggregated targeted investments increased by $5 million dollars during a three-month forward contract, then the counter-party would have to pay the plan sponsor $5 million (less any fees) at the end of the forward contract. Conversely, if the value of the aggregated targeted investments decreased by $5 million dollars during a three-month forward contract, then the plan sponsor would have to pay the counter-party $5 million (plus any fees) at the end of the forward contract.

When a hedging transaction comes to an end at the end of a settlement period, a hedging transaction settlement process is used, as illustrated in FIG. 12. In step 1200, the system determines the tax-deferred gain or loss resulting from the hedging transaction for each mini-hedge at the payout bucket level. For this example, it is assumed that a value corresponding to PP1:PB1 increased by $5 as a result of an increase in targeted investment W. The aggregate for the group level and at the overall plan level is determined in step 1210.

As shown in step 1220, the tax-deferred gain or loss of each hedging transaction that ended in the settlement period is accumulated at the mini-hedge level with any other previous existing tax-deferred gain or loss for a corresponding payout bucket. If PP1:PB1 previously had a gain of $10 from investment P and a loss of $4 from investment Q, then the accumulated gain for PP1:PB1 would be $10−$4+$5=$11. The system may also accumulate the tax-deferred gain or loss from hedging transactions that ended in the settlement period at each group level and at the overall plan level with any other previous existing tax-deferred gain or loss at each group level and at the overall plan level.

As shown in step 1230, the discharge of all benefit liabilities is tracked at the payout bucket level. The benefit payments, forfeitures and adjustments are combined to determine a total dollar amount corresponding to the payout bucket. The total liability at the payout bucket level can then be used to calculate a percentage of deferred balances to realize.

In step 1240, the total deferred balances of gains, losses, fees, charges, etc. associated with the discharge of liabilities at the payout bucket level are calculated using the percentages determined in step 1230. The system may also calculate the total deferred balances of gains, losses, fees, charges, interest, etc. associated with the discharge of liabilities at the group level and at the overall plan level.

From there, the tax impact, deferred balances of gains/losses, fees, charges, interest, etc. associated with the discharge of liabilities can be reported to the plan sponsor as shown in step 1250. In step 1260, the system reports the cash balances to be paid or received due to (1) the hedging transaction gains and losses, fees, charges, interest, etc. and (2) the cash balance of dividends to be paid out, if applicable. These amounts can be reported to either or both of the plan sponsor and the counter-party.

At the end of each settlement period, it is also possible for a plan sponsor to change the mappings of referenced funds to targeted investments.

As described herein, a plan sponsor agrees with a counter-party to enter into a hedging transaction to manage its exposure to a plan liability. It is possible to utilize plural counter-parties in a single transaction (e.g., hedging a first half with a first counter-party and hedging a second half with a second counter-party). It is also possible, at the end of a hedging transaction, for the plan sponsor to select a different counter-party for a next settlement period than was used for a now ending settlement period.

As described herein, various administration functions are performed periodically. In one preferred embodiment, administration functions are performed as follows:

Monthly: execute a snapshot of liability information; value existing hedging transactions; calculate hedging transaction status; calculate rebalancing adjustments; and communicate recommended adjustments to plan sponsor;

Quarterly: receive and confirm hedge results; calculate and verify fees and proceeds of hedging transactions; store hedging transactions results; communicate results to plan sponsor and counter-party; and calculate and communicate recommended new hedging transactions based on historical information;

Annually: roll-up quarterly hedging transactions results; report current tax impact and deferred balances to realize, produce summary report of liability changes; and review hedging transactions options.

The present invention can also track values corresponding to hedging transactions that do not qualify for favorable tax treatment under the special hedging transaction rules. These hedging transactions can be tracked by the system 50, but the tax advantages of the special hedging transaction rules are not available. Thus, the system 50 simply tracks the gains and losses, fees, charges, interest, etc. of the hedging transaction on an aggregate basis and by group and reports the results to the plan sponsor and the counter-party.

The present invention also includes the ability to turn on and off the tracking of plan participants. For example, if a plan participant is transferred from a group that is eligible for hedging to a group that is not eligible for hedging, then the system 50 must be informed so that the plan participant can be included in the proper group.

The system may also perform a number of plan monitoring functions. One such monitoring function is the tracking of gains/losses of referenced funds as compared with their current mappings to targeted investments. This will enable a plan sponsor to determine if the current mappings of a referenced fund to a targeted investment should be changed.

To more precisely analyze how effective a mapping is, the plan sponsor may wish to receive reports on either or both of total dollar changes and total percentage changes over the monitoring period.

However, by looking only at amounts invested in a referenced fund at the beginning and end of a monitoring period and comparing them with amounts invested in a corresponding targeted investment at the beginning and end of the monitoring period, it is possible to misinterpret how well the referenced fund is matching the targeted investment. That simple approach would not capture the situation where a portion of the under- or over-performance is due to plan participant changes and not to the growth or loss of the underlying investments. (Plan participant changes include, but are not limited to, reallocations, additions, payouts and forfeitures.) As a result, the system may also provide the ability to receive reports of dollar changes adjusted for plan participant changes (at the group level or at the plan level), and percentage changes adjusted for plan participant changes (at the group level or at the plan level).

In addition to monitoring how well a targeted investment is matching a referenced fund, the system may utilize historical data to suggest alternate mappings of referenced funds to targeted investments. For example, in order to find a good match for a referenced fund (e.g., the S&P 500), the performance of a number of targeted investments are compared against the referenced fund using statistical analysis. If there is another targeted investment that has consistently performed more closely to the referenced fund than the current mapping, then the system suggests a change. Such a suggestion may include one or more funds, and correlation factors indicating how closely the other targeted investments would have matched, as compared with the current mapping. The plan sponsor may then elect to change the mapping.

The system may also track, on behalf of the plan sponsor, other statistics, such as the running tax deferral at a payout bucket, plan participant, group or plan level.

While the present invention has been described in terms of a number of specific embodiments, it should be understood that the present invention is not limited by the description given hereinabove, but rather the scope of protection is limited only by the claims below. Accordingly, the present invention can be practiced using variations of the above teaching and still fall within the scope of the claims herein.

1. A computer-implemented method of managing a non-qualified, deferred compensation program utilizing at least one qualifying hedging transaction, comprising the steps of:
establishing plural deferred amounts for at least one referenced fund of plural payout buckets of plural plan participants;
mapping at least one of the at least one referenced fund to at least one targeted investment utilizing at least one qualifying hedging transaction to determine at least one targeted investment amount in each of the at least one targeted investment;
establishing the at least one qualifying hedging transaction for the at least one targeted investment amount with at least one counterparty;
tracking, on a payout bucket basis, a change in values of the at least one targeted investment; and
tracking, on a payout bucket basis, at least one of tax-deferred gains, tax-deferred losses, tax-deferred fees and tax-deferred amounts corresponding to the at least one qualifying hedging transaction.

2. The computer-implemented method according to claim 1, wherein:
the step of mapping comprises aggregating targeted investment amounts corresponding to the at least one referenced fund of the plural payout buckets of the plural plan participants on a targeted investment-by-targeted investment basis into aggregated targeted investment amounts; and
the step of establishing comprises establishing the at least one qualifying hedging transaction as at least one aggregate transaction for the aggregated targeted investment amounts.

3. The computer-implemented method according to claim 2, wherein the step of aggregating targeted investment amounts comprises the steps of:
specifying a first group of plan participants from the plural plan participants; and
aggregating targeted investment amounts based on the first group of plan participants.

4. The computer-implemented method according to claim 1, further comprising tracking changes in plural payout buckets using transactions that do not qualify for deferred tax treatment.

5. The computer-implemented method according to claim 3, further comprising:
specifying a second group of plan participants from the plural plan participants;
aggregating targeted investments based on the second group of plan participants;
tracking, on a payout bucket basis, a change in values of the at least one targeted investment associated with the second group of plan participants; and
tracking, on a payout bucket basis, at least one of tax-deferred gains, tax-deferred losses, tax-deferred fees and tax-deferred amounts corresponding to a portion of the at least one qualifying hedging transaction corresponding to the second group if the step of aggregating determines that the targeted investment amount of the second group is greater than a threshold.

6. The computer-implemented method according to claim 1, wherein the step of tracking a change comprises tracking a change in an underlying value of the at least one targeted investment.

7. The computer-implemented method according to claim 1, wherein the step of tracking a change comprises tracking a change based on payment of at least one of a dividend and a distribution corresponding to at least one of the at least one targeted investment.

8. The computer-implemented method according to claim 1, wherein at least one payout bucket of the plural payout buckets comprises a payout bucket with plural referenced funds.

9. The computer-implemented method of claim 1, further comprising communicating the plural deferred amounts to a plan sponsor at at least one of a plan participant level, a group level and a plan sponsor level.

10. The computer-implemented method of claim 1, further comprising communicating the at least one targeted investment amount to a plan sponsor at at least one of a plan participant level, a group level and a plan sponsor level.

11. The computer-implemented method of claim 1, further comprising communicating the at least one targeted investment amount to a plan sponsor on a targeted investment-by-targeted investment basis.

12. The computer-implemented method of claim 3, further comprising communicating the aggregated initial targeted investment amounts to a plan sponsor on a group-by-group basis.

13. The computer-implemented method of claim 1, wherein at least one of the tax-deferred fees comprises a fee assessed at at least one of a payout bucket level and a plan participant level.

14. The computer-implemented method of claim 3, wherein at least one of the tax-deferred fees comprises a pro rata portion of a fee assessed at at least one of a group level and a plan sponsor level.

15. The computer-implemented method of claim 1, wherein the tax-deferred fees comprise at least one of a licensing fee, an administration fee and a counter-party fee.

16. The computer-implemented method of claim 5, wherein the first and second groups correspond to plan participants working for different legal entities.

17. The computer-implemented method according to claim 1, further comprising determining a change in a liability associated with at least one of the plural payout buckets of at least one of the plural plan participants.

18. The computer-implemented method according to claim 17, wherein determining comprises determining a change in the at least one of the plural payout buckets based on at least one of an additional deferral, a reallocation, a benefit payment and a forfeiture.

19. The computer-implemented method according to claim 17, further comprising rebalancing at least one of the at least one targeted investment based on a change in the liability associated with the at least one of the plural payout buckets.

20. The computer-implemented method of claim 1, further comprising accumulating, on a payout bucket basis, at least one of tax-deferred gains, tax-deferred losses, tax-deferred fees and tax-deferred amounts.

21. The computer-implemented method of claim 1, further comprising tracking, on a payout bucket basis, at least one of gains and losses from the at least one qualifying hedging transaction at the end of a settlement period.

22. The computer-implemented method of claim 21, further comprising reporting to a plan sponsor at least one of gains and losses from the at least one qualifying hedging transaction at the end of the settlement period.

23. A computer-implemented method of managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, comprising the steps of:
establishing deferred amounts for each referenced fund in each of the payout buckets;
aggregating up to the plan sponsor level the deferred amounts for each referenced fund in each of the payout buckets to create deferred aggregated amounts at the plan sponsor level for each of the referenced funds;
mapping at least one referenced fund corresponding to at least one of the payout buckets to at least one targeted investment utilizing at least one qualifying hedging transaction to determine, from the deferred aggregated amounts, at least one targeted investment amount in each of the at least one targeted investment;
establishing the at least one qualifying hedging transaction for the at least one targeted investment amount with at least one counterparty;
tracking, on a payout bucket basis, a change in values of the at least one targeted investment; and
tracking, on a payout bucket basis, at least one of tax-deferred gains, tax-deferred losses, tax-deferred fees and tax-deferred amounts corresponding to the at least one qualifying hedging transaction.

24. The computer-implemented method of claim 23, wherein the step of aggregating comprises:
aggregating up to the group level the deferred amounts for each referenced fund in each of the payout buckets to create deferred aggregated amounts at the group level for each referenced fund in the payout buckets; and
aggregating up to the plan level the deferred amounts at the group level to create the deferred aggregated amounts at the plan sponsor level for each referenced fund in the payout buckets.

25. A computer-implemented method of managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, comprising the steps of:
tracking periodically, at the payout bucket level, changes in liabilities to plan participants;
tracking periodically, at the plan sponsor level, a value of at least one targeted investment including at least one qualifying hedging transaction; and
tracking periodically, at the payout bucket level, at least one of tax-deferred gains, tax-deferred losses, tax-deferred fees and tax-deferred amounts corresponding to the at least one hedging transaction.

26. The computer-implemented method of claim 25, wherein the step of tracking periodically, at the payout bucket level, changes in liabilities to plan participants comprises tracking at least one of a change in a value of a referenced fund, an addition of another deferral, a benefit payout, a forfeiture, and a change in allocation in a referenced fund.

27. The computer-implemented method of claim 25, wherein the step of tracking periodically, at the plan sponsor level, a value of at least one targeted investment comprises at least one of tracking a change in a value of at least one targeted investment and tracking a payout of a dividend.

28. The computer-implemented method of claim 25, further comprising tracking a settlement due between a plan sponsor and a counterparty at the end of a settlement period.

29. The computer-implemented method of claim 25, wherein the step of tracking periodically, at the payout bucket level, at least one of tax-deferred gains, tax-deferred losses, tax-deferred fees and tax-deferred amounts corresponding to the at least one hedging transaction comprises aggregating up to the group level the at least one of tax-deferred gains, tax-deferred losses, tax-deferred fees and tax-deferred amounts corresponding to the at least one hedging transaction.

30. The computer-implemented method of claim 25, wherein the step of tracking periodically, at the payout bucket level, at least one of tax-deferred gains, tax-deferred losses, tax-deferred fees and tax-deferred amounts corresponding to the at least one hedging transaction comprises reporting to the plan sponsor, at at least one of the plan participant level, the group level and the plan sponsor level, the at least one of tax-deferred gains, tax-deferred losses, tax-deferred fees and tax-deferred amounts corresponding to the at least one hedging transaction.

31. The computer-implemented method of claim 25, wherein the step of tracking periodically, at the payout bucket level, at least one of tax-deferred gains, tax-deferred losses, tax-deferred fees and tax-deferred amounts corresponding to the at least one hedging transaction comprises assessing pro rata amounts to payout buckets based on fees assessed at one of the group level and the plan sponsor level.

32. The computer-implemented method of claim 25, wherein the step of tracking periodically, at the payout bucket level, at least one of tax-deferred gains, tax-deferred losses, tax-deferred fees and tax-deferred amounts corresponding to the at least one hedging transaction comprises accumulating, at the payout bucket level, the at least one of tax-deferred gains, tax-deferred losses, tax-deferred fees and tax-deferred amounts corresponding to the at least one hedging transaction.

33. The computer-implemented method of claim 25, further comprising tracking periodically, at the group level, the tax-deferred fees due to at least one of a record keeper, an administrator and a licensor.

34. The computer-implemented method of claim 25, further comprising tracking periodically, at the plan level, the tax-deferred fees due to at least one of a record keeper, an administrator and a licensor.

35. The computer-implemented method of claim 33, further comprising reporting to the plan sponsor at the group level the tax-deferred fees due to at least one of a record keeper, an administrator and a licensor.

36. The computer-implemented method of claim 34, further comprising reporting to the plan sponsor at the plan sponsor level the tax-deferred fees due to at least one of a record keeper, an administrator and a licensor.

37. The computer-implemented method of claim 25, wherein the step of tracking periodically, at the plan sponsor level, a value of at least one targeted investment comprises aggregating up values of the at least one targeted investments from the group level.

38. The computer-implemented method of claim 25, wherein the step of tracking periodically, at the plan sponsor level, a value of at least one targeted investment comprises aggregating up values of the at least one targeted investment from the plan participant level.

39. The computer-implemented method of claim 25, wherein the step of tracking periodically, at the plan sponsor level, a value of at least one targeted investment comprises aggregating up values of the at least one targeted investment from the payout bucket level.

40. The computer-implemented method of claim 25, further comprising periodically rebalancing amounts allocated to the at least one targeted investment.

41. The computer-implemented method of claim 40, further comprising periodically rebalancing, using a percentage of liabilities, amounts allocated to the at least one targeted investment.

42. The computer-implemented method of claim 40, wherein the step of periodically rebalancing amounts allocated to the at least one targeted investment comprises reporting to the plan sponsor a rebalancing amount for each targeted investment to be rebalanced.

43. The computer-implemented method of claim 25, wherein the step of tracking periodically, at the payout bucket level, at least one of tax-deferred gains, tax-deferred losses, tax-deferred fees and tax-deferred amounts corresponding to the at least one hedging transaction comprises calculating a percentage of tax-deferred fees that are currently deductible based on liabilities discharged.

44. The computer-implemented method of claim 43, further comprising reporting to the plan sponsor the percentage of tax-deferred fees that are currently deductible based on liabilities discharged.

45. The computer-implemented method of claim 25, wherein the step of tracking periodically, at the payout bucket level, at least one of tax-deferred gains, tax-deferred losses, tax-deferred fees and tax-deferred amounts corresponding to the at least one hedging transaction comprises calculating a percentage of tax-deferred gains and losses that are currently deductible based on liabilities discharged.

46. The computer-implemented method of claim 45, further comprising reporting to the plan sponsor the percentage of tax-deferred gains and losses that are currently deductible based on liabilities discharged.

47. The computer-implemented method according to claim 6, wherein the step of tracking a change in an underlying value of the at least one targeted investment comprises communicating with at least one information source to obtain information on the at least one targeted investment.

48. The computer-implemented method according to claim 3, further comprising:
aggregating targeted investments based on the first group of plan participants;
tracking, on a payout bucket basis, a change in values of the at least one targeted investment associated with the first group of plan participants; and
tracking, on a payout bucket basis, at least one of tax-deferred gains, tax-deferred losses, tax-deferred fees and tax-deferred amounts corresponding to one of the targeted investments of the first group if the step of aggregating determines that an amount to be invested by the first group in the one of the targeted investments is greater than a threshold.

49. The computer-implemented method of claim 1, wherein at least one of the tax-deferred fees comprises a fee assessed at the plan level.

50. The computer-implemented method according to claim 17, further comprising rebalancing, using a percentage of liability method, at least one of the at least one targeted investment based on a change in the liability associated with the at least one of the plural payout buckets.

51. The computer-implemented method of claim 1, further comprising receiving from a plan sponsor at least one of forfeitures, deferrals and mappings of referenced funds to targeted investments.

52. The computer-implemented method of claim 23, further comprising:
aggregating up to the group level the at least one targeted investment amount; and
aggregating up to the plan level the aggregated targeted investment amounts at the group level to create aggregated investment amounts at the plan sponsor level.

53. The computer implemented method of claim 28, wherein the step of tracking a settlement due between a plan sponsor and a counterparty at the end of a settlement period comprises tracking (1) a payout of at least one of a dividend and a distribution and (2) a payout of the at least one qualifying hedging transaction.

54. The computer implemented method of claim 25, further comprising tracking at least one of non-tax-deferred fees and costs for deduction in a current period.

55. The computer-implemented method of claim 25, further comprising:
tracking changes in a value of the at least one referenced fund as compared with changes in a value of the at least one targeted investment; and
altering a mapping of the at least one referenced fund if the step of tracking changes in a value of the at least one referenced fund determines that the value of the at least one referenced fund and the value of the at least one targeted investment differ by a specified threshold.

56. The computer-implemented method of claim 55, wherein the threshold is a percentage.

57. The computer-implemented method of claim 55, wherein the step of altering comprises prompting a user to select at least one targeted investment with a return closer to a return of the at least one referenced fund.

58. The computer-implemented method according to claim 17, further comprising rebalancing at least one of the at least one targeted investment based on a change in the liability associated with the at least one of the plural payout buckets if a difference between (1) the liabilities associated with a corresponding referenced fund and (2) a value of a corresponding targeted investment of the at least one targeted investment is greater than a threshold.

59. The computer-implemented method according to claim 58, wherein the threshold is a percentage threshold.

60. The computer-implemented method of claim 23, further comprising:
aggregating up to the group level at least one of tax-deferred fees and tax-deferred amounts corresponding to the at least one hedging transaction; and
aggregating up to the plan level the at least one of tax-deferred fees and tax-deferred amounts at the group level to create at least one of aggregated tax-deferred fees and aggregated tax-deferred amounts at the plan sponsor level.

61. The computer-implemented method of claim 23, further comprising:
aggregating up to the group level at least one of tax-deferred gains and tax-deferred losses corresponding to the at least one hedging transaction; and
aggregating up to the plan level the at least one of tax-deferred gains and tax-deferred losses at the group level to create at least one of aggregated tax-deferred gains and aggregated tax-deferred losses at the plan sponsor level.

62. A system for tracking a non-qualified, deferred compensation program utilizing at least one qualifying hedging transaction, the program having been established according to the steps of:
establishing plural deferred amounts for at least one referenced fund of plural payout buckets of plural plan participants;
mapping at least one of the at least one referenced fund to at least one targeted investment utilizing at least one qualifying hedging transaction to determine at least one targeted investment amount in each of the at least one targeted investment;
establishing the at least one qualifying hedging transaction for the at least one targeted investment amount with at least one counterparty, the system comprising:
a first tracking component configured to track, on a payout bucket basis, a change in values of the at least one targeted investment; and
a second tracking component configured to track, on a payout bucket basis, at least one of tax-deferred gains, tax-deferred losses, tax-deferred fees and tax-deferred amounts corresponding to the at least one qualifying hedging transaction.

63. A system for managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, the program having been established according to the steps of:
establishing deferred amounts for each referenced fund in each of the payout buckets;
aggregating up to the plan sponsor level the deferred amounts for each referenced fund in each of the payout buckets to create deferred aggregated amounts at the plan sponsor level for each of the referenced funds;
mapping at least one referenced fund corresponding to at least one of the payout buckets to at least one targeted investment utilizing at least one qualifying hedging transaction to determine, from the deferred aggregated amounts, at least one targeted investment amount in each of the at least one targeted investment;
establishing the at least one qualifying hedging transaction for the at least one targeted investment amount with at least one counterparty, the system comprising:
a first tracking component configured to track, on a payout bucket basis, a change in values of the at least one targeted investment; and
a second tracking component configured to track, on a payout bucket basis, at least one of tax-deferred gains, tax-deferred losses, tax-deferred fees and tax-deferred amounts corresponding to the at least one qualifying hedging transaction.

64. A system for managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, the system comprising:
a first tracking component configured to track periodically, at the payout bucket level, changes in liabilities to plan participants;
a second tracking component configured to track periodically, at the plan sponsor level, a value of at least one targeted investment including at least one qualifying hedging transaction; and
a third tracking component configured to track periodically, at the payout bucket level, at least one of tax-deferred gains, tax-deferred losses, tax-deferred fees and tax-deferred amounts corresponding to the at least one hedging transaction.

65. A system for tracking a non-qualified, deferred compensation program utilizing at least one qualifying hedging transaction, the program having been established according to the steps of:
establishing plural deferred amounts for at least one referenced fund of plural payout buckets of plural plan participants;
mapping at least one of the at least one referenced fund to at least one targeted investment utilizing at least one qualifying hedging transaction to determine at least one targeted investment amount in each of the at least one targeted investment;
establishing the at least one qualifying hedging transaction for the at least one targeted investment amount with at least one counterparty, the system comprising:
first means for tracking, on a payout bucket basis, a change in values of the at least one targeted investment; and
second means for tracking, on a payout bucket basis, at least one of tax-deferred gains, tax-deferred losses, tax-deferred fees and tax-deferred amounts corresponding to the at least one qualifying hedging transaction.

66. A system for managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, the program having been established according to the steps of:
establishing deferred amounts for each referenced fund in each of the payout buckets;
aggregating up to the plan sponsor level the deferred amounts for each referenced fund in each of the payout buckets to create deferred aggregated amounts at the plan sponsor level for each of the referenced funds;
mapping at least one referenced fund corresponding to at least one of the payout buckets to at least one targeted investment utilizing at least one qualifying hedging transaction to determine, from the deferred aggregated amounts, at least one targeted investment amount in each of the at least one targeted investment;
establishing the at least one qualifying hedging transaction for the at least one targeted investment amount with at least one counterparty, the system comprising:
first means for tracking, on a payout bucket basis, a change in values of the at least one targeted investment; and
second means for tracking, on a payout bucket basis, at least one of tax-deferred gains, tax-deferred losses, tax-deferred fees and tax-deferred amounts corresponding to the at least one qualifying hedging transaction.

67. A system for managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, the system comprising:
first means for tracking periodically, at the payout bucket level, changes in liabilities to plan participants;
second means for tracking periodically, at the plan sponsor level, a value of at least one targeted investment including at least one qualifying hedging transaction; and
third means for tracking periodically, at the payout bucket level, at least one of tax-deferred gains, tax-deferred losses, tax-deferred fees and tax-deferred amounts corresponding to the at least one hedging transaction.

68. A computer-program product for tracking a non-qualified, deferred compensation program utilizing at least one qualifying hedging transaction, the program having been established according to the steps of:
establishing plural deferred amounts for at least one referenced fund of plural payout buckets of plural plan participants;
mapping at least one of the at least one referenced fund to at least one targeted investment utilizing at least one qualifying hedging transaction to determine at least one targeted investment amount in each of the at least one targeted investment;
establishing the at least one qualifying hedging transaction for the at least one targeted investment amount with at least one counterparty, the computer program product comprising a computer readable medium and computer code embedded on the computer readable medium for controlling a computer to perform the steps of:
tracking, on a payout bucket basis, a change in values of the at least one targeted investment; and
tracking, on a payout bucket basis, at least one of tax-deferred gains, tax-deferred losses, tax-deferred fees and tax-deferred amounts corresponding to the at least one qualifying hedging transaction.

69. A computer-program product for managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, the program having been established according to the steps of:
establishing deferred amounts for each referenced fund in each of the payout buckets;
aggregating up to the plan sponsor level the deferred amounts for each referenced fund in each of the payout buckets to create deferred aggregated amounts at the plan sponsor level for each of the referenced funds;
mapping at least one referenced fund corresponding to at least one of the payout buckets to at least one targeted investment utilizing at least one qualifying hedging transaction to determine, from the deferred aggregated amounts, at least one targeted investment amount in each of the at least one targeted investment;
establishing the at least one qualifying hedging transaction for the at least one targeted investment amount with at least one counterparty,
the computer program product comprising a computer readable medium and computer code embedded on the computer readable medium for controlling a computer to perform the steps of:
tracking, on a payout bucket basis, a change in values of the at least one targeted investment; and
tracking, on a payout bucket basis, at least one of tax-deferred gains, tax-deferred losses, tax-deferred fees and tax-deferred amounts corresponding to the at least one qualifying hedging transaction.

70. A computer program product for managing a non-qualified, deferred compensation program utilizing at least one hedging transaction, wherein the program comprises plural plan participants, each with at least one payout bucket, thereby establishing a multi-level plan hierarchy including at least a payout bucket level, a plan participant level, and a plan level, the computer program product comprising a computer readable medium and computer code embedded on the computer readable medium for controlling a computer to perform the steps of:
tracking periodically, at the payout bucket level, changes in liabilities to plan participants;
tracking periodically, at the plan sponsor level, a value of at least one targeted investment including at least one qualifying hedging transaction; and
tracking periodically, at the payout bucket level, at least one of tax-deferred gains, tax-deferred losses, tax-deferred fees and tax-deferred amounts corresponding to the at least one hedging transaction.
